(19) United States
(12) Patent Application Publication
(10) Pub. No.: US 2015/0302366 A1
(43) Pub. Date: Oct. 22, 2015

(54) SYSTEM AND METHODS FOR MANAGING PAYMENTS

(71) Applicants: Farid Khan, Toronto (CA); Aiiaz Khan, Mississauga (CA)

(72) Inventors: Farid Khan, Toronto (CA); Aiiaz Khan, Mississauga (CA)

(73) Assignee: Caaritra Inc., Toronto (CA)

(21) Appl. No.: 14/111,260

(22) PCT Filed: Apr. 5, 2012
(86) PCT No.: PCT/CA12/00340

§ 371 Date: Jun. 24, 2015

Related U.S. Application Data
(60) Provisional application No. 61/474,086, filed on Apr. 11, 2011.

(51) Int. Cl. G06Q 20/08; G06Q 50/00; G06Q 20/38

(52) U.S. Cl. CPC G06Q 20/085; G06Q 20/389; G06Q 50/01

(57) ABSTRACT

The described embodiments relate to systems, method and computer readable medium for managing payments, such as donations, collected by an administrator on behalf of a recipient. The systems, method and computer readable medium for managing payments are operable to track payment requests, received payments, ratings, status updates, feedback.

### FIELD

The described embodiments relate to systems and methods for managing payments, such as payments received as donations, and in particular, to systems and methods for managing payments collected by an administrator on behalf of a recipient.

### BACKGROUND

A person may be in need of financial aid and may attempt to raise money by soliciting donations and payments from other people. The person in need of financial aid may not know many other people who are in a position to donate money, which may limit their ability to raise the necessary money.

An electronic social network creates links between users who are socially connected, such as friends, relatives, colleagues, associates, and so on. An electronic social network facilitates communication between users. Other electronic networks also facilitate communication between people, such as the Internet, local area networks, and wide area networks, for example. Users can also electronically communicate using electronic mail, short messaging service, multimedia messaging service and so on.

### SUMMARY

In a first aspect, some embodiments provide a method for managing payments, such as donations. The method may comprise: registering an administrator in a database, wherein the administrator collects payments on behalf of a recipient; receiving a confirmation that one or more payment requests were sent from the administrator to a first set of one or more potential payors over one or more networks, wherein the one or more payment requests are associated with the recipient; storing a link between the administrator and each potential payor of the first set of one or more first potential payors in the database; receiving a confirmation that one or more payment requests were sent from a potential payor of the first set of one or more potential payors to a second set of one or more potential payors over a network, wherein the one or more payment requests are associated with the recipient; storing a link between the potential payor of the first set of one or more potential payors and each potential payor of the second set of one or more potential payors in the database; receiving one or more payments for the recipient from a corresponding one or more payors of the second set of one or more potential payors; and for each of the one or more received payments, storing data identifying the received payment in association with the corresponding payor.

In accordance with some embodiments, the method may further comprise: for each of the one or more received payments, sending a notification of the received payment to the administrator.

In accordance with some embodiments, the method may further comprise receiving government identification from the administrator and verifying the administrator's government identification. In accordance with some embodiments, the method may further comprise receiving government identification for the recipient and verifying the recipient's government identification.

In accordance with some embodiments, the method may further comprise: for each of the one or more received payments, sending a notification of the received payment to the potential payor of the first set of one or more potential payors.

In accordance with some embodiments, the method may further comprise: receiving a confirmation that one or more payment requests were sent from a potential payor of the second set of one or more potential payors to a third set of one or more potential payors over a network, wherein the one or more payment request is associated with the recipient; storing a link between the potential payor of the second set of one or more potential payors and each potential payor of the third set of one or more potential payors in the database; receiving one or more payments for the recipient from a corresponding one or more payors of the third set of one or more potential payors; and for each of the one or more received payments, storing data identifying the received payment in association with the corresponding payor.

In accordance with some embodiments, the method may further comprise: receiving a status update message associated with the recipient from the administrator; and forwarding the status update message to each of the one or more payors payments were received from.

In accordance with some embodiments, the method may further comprise: sending a payment subscription request to the each potential payor of the first set of potential payors and the second of potential payors, wherein the payment subscription request defines a periodic time for payment; receiving payment subscription authorizations from one or more potential payors of the first set of potential payors and the second of potential payors; recording data identifying the payment subscription authorization in association with the each of the one or more potential payors payment subscription authorizations were received from; and at each occurrence of the periodic time for donating, receiving a payment for the recipient from each of the one or more potential payors payment subscription authorizations were received from.

In accordance with some embodiments, the method may further comprise: at each occurrence of the periodic time for donating, sending a payment reminder to each of the one or more potential payors payment subscription authorizations were received from.

In accordance with some embodiments, the method may further comprise: receiving rating indicia for the administrator from one or more potential payors of the first set of potential payors and the second of potential payors; computing a rating for the administrator using the rating indicia; and storing the computed rating in association with the administrator. In accordance with some embodiments, the rating indicia may be based on the total amount of payments received from the first set of potential payors and the second of potential payors.

In accordance with some embodiments, the method may further comprise: receiving a status update message associated with the recipient from the administrator; forwarding the status update message to each payor payment for the recipient was received from; and receiving one or more ratings for the status update message from one or more potential payors that the status update message was forwarded to; and wherein the rating indicia may based on one or more received ratings for the status update message.

In accordance with some embodiments, the method may further comprise: receiving one or more feedback indicia in relation to the administrator from one or more potential payors of the first set of potential payors and the second of potential payors; and wherein the rating indicia is based on the one or more received feedback indicia.

In accordance with some embodiments, the method may further comprise: receiving rating indicia for the recipient from one or more potential payors of the first set of potential payors and the second of potential payors; computing a rating for the recipient using the rating indicia; and storing the computed rating in association with the recipient.

In accordance with some embodiments, the method may further comprise: for each received confirmations that one or more payment requests were sent: receiving a date and time of the payment request; and storing the received date and time.

In accordance with some embodiments, the method may further comprise: for each potential payor: determining a number of times a payment request was sent to the potential payor; and storing the number of times in association with the potential payor.

In accordance with some embodiments, the method may further comprise: for each payor: determining a number of times a payment was received from the payor; and storing the number of times in association with the payor.

In accordance with some embodiments, the method may further comprise: sending a recommendation of one or more potential payors to send a payment request to, wherein the recommendation is based on the number of times payment was received from the one or more potential payors.

In accordance with another aspect, embodiments described herein provide a computer-readable storage device comprising a plurality of instructions for an application, the application for execution on a computing device, the instructions for performing a method of managing payments comprising: registering an administrator in a database, wherein the administrator collects payments on behalf of a recipient;

receiving a confirmation that one or more payment requests were sent from the administrator to a first set of one or more potential payors over one or more networks, wherein the one or more payment requests are associated with the recipient; storing a link between the administrator and each potential payor of the first set of one or more first potential payors in the database; receiving a confirmation that one or more payment requests were sent from a potential payor of the first set of one or more potential payors to a second set of one or more potential payors over a network, wherein the one or more payment requests are associated with the recipient; storing a link between the potential payor of the first set of one or more potential payors and each potential payor of the second set of one or more potential payors in the database; receiving one or more payments for the recipient from a corresponding one or more potential payors of the second set of one or more potential payors; and for each of the one or more received payments, storing data identifying the received payment in association with the corresponding potential payor.

In accordance with another aspect, embodiments described herein provide a system for managing payments, the system comprising a processor and a memory on which an application is installed; wherein execution of the application causes the processor to: register an administrator in a database, wherein the administrator collects payments on behalf of a recipient; receive a confirmation that one or more payment requests were sent from the administrator to a first set of one or more potential payors over one or more networks, wherein the one or more payment requests are associated with the recipient; store a link between the administrator and each potential payor of the first set of one or more first potential payors in the database; receive a confirmation that one or more payment requests were sent from a potential payor of the first set of one or more potential payors to a second set of one or more potential payors over a network, wherein the one or more payment requests are associated with the recipient; store a link between the potential payor of the first set of one or more potential payors and each potential payor of the second set of one or more potential payors in the database; receive one or more payments for the recipient from a corresponding one or more potential payors of the second set of one or more potential payors; and for each of the one or more received payments, store data identifying the received payment in association with the corresponding potential payor.

### BRIEF DESCRIPTION OF THE DRAWINGS

For a better understanding of embodiments of the systems and methods described herein, and to show more clearly how they may be carried into effect, reference will be made, by way of example, to the accompanying drawings in which:

FIG. 1 is a block diagram of a system for managing payments in accordance with at least one embodiment;

FIG. 2 is a block diagram of a payor device in accordance with at least one embodiment;

FIG. 3 is a block diagram of an administrator device in accordance with at least one embodiment;

FIG. 4 is a flowchart diagram of a method for managing payments in accordance with at least one embodiment;

FIG. 5 is a schematic diagram of a graph illustrating links between the administrator and potential payors in accordance with at least one embodiment;

FIG. 6 is a flowchart diagram of a method for managing payments in accordance with at least one other embodiment;

FIG. 7 is a flowchart diagram of a method for sending notifications of received payments in accordance with at least one embodiment;

FIG. 8 is a flowchart diagram of a method for managing ratings in accordance with at least one embodiment;

FIG. 9 is a flowchart diagram of a method for providing status updates for a recipient in accordance with at least one embodiment;

FIG. 10 shows an interface for registering an administrator in accordance with at least one embodiment;

FIG. 11 shows an interface for registering a recipient for the collection donations in accordance with at least one embodiment;

FIG. 12 shows an interface providing a recipient verification page in accordance with at least one embodiment;

FIG. 13 shows an interface for creating a donation request profile page for collecting donations on behalf of a recipient in accordance with at least one embodiment;

FIG. 14 shows an interface displaying a donor record page and data regarding the donor in accordance with at least one embodiment;

FIG. 15 shows an interface for adding a new contact in accordance with at least one embodiment;

FIG. 16 shows an interface displaying a set of contacts for a specific administrator in accordance with at least one embodiment;

FIG. 17 shows an interface for sending donation requests to potential donors in accordance with at least one embodiment;

FIG. 18 shows an interface for displaying a donation request response page to enable a donor to respond to a received donation request in accordance with at least one embodiment;

FIG. 19 shows a notification for provision to administrator device indicating that a donor has made a donation for a donation program associated with the administrator in accordance with at least one embodiment;

FIG. 20 shows an interface for forwarding donation requests to additional potential donors in accordance with at least one embodiment;

FIG. 21 shows an interface for providing a donation request for a donation collection in accordance with at least one embodiment;

FIG. 22 shows a notification composed and provided by system to an administrator indicating that a portion of the collected donations has been disbursed to the recipient in accordance with at least one embodiment;

FIG. 23 shows an interface displaying a status update page for receiving status updates in accordance with at least one embodiment;

FIG. 24 shows an interface for displaying a show status update page with details regarding the status update in accordance with at least one embodiment;

FIG. 25 shows an interface for collecting feedback indicia regarding recipients, status update messages in accordance with at least one embodiment;

FIG. 26 shows an interface for displaying a donation listing page providing details regarding donation programs in accordance with at least one embodiment; and

FIG. 27 shows an interface for providing a renewal page for renewing a donation.

The drawings, described below, are provided for purposes of illustration of the aspects and features of various examples of embodiments described herein. For simplicity and clarity of illustration, elements shown in the figures have not necessarily been drawn to scale. The dimensions of some of the elements may be exaggerated relative to other elements for clarity. Further, where considered appropriate, reference numerals may be repeated among the figures to indicate corresponding or analogous elements.

### DESCRIPTION OF EXEMPLARY EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description should be considered as describing implementation of the various embodiments described herein.

The systems, processes and methods of the described embodiments are capable of being implemented in a computer program product comprising a non-transitory computer readable medium that stores computer usable instructions for one or more processors that cause the one or more processors to operate in a specific and predefined manner to perform the functions described herein. The medium may be provided in various forms, including as volatile or non-volatile memory provided on optical, magnetic or electronic storage media.

The embodiments of the systems and methods described herein may be implemented in hardware or software, or a combination of both. These embodiments may be implemented in computer programs executing on programmable computers, each computer including at least one processor, a data storage system (including volatile and non-volatile memory and/or storage elements), and at least one communication interface. For example, and without limitation, the various programmable computers may be a server, network appliance, set-top box, embedded device, computer expansion module, personal computer, laptop, personal data assistant, cellular telephone, smartphone device, mobile device, UMPC tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication. In still other embodiments, there may be a combination of communication interfaces implemented as hardware, software, and combination thereof.

Each program may be implemented in a high level procedural or object oriented programming or scripting language, or both, to communicate with a computer system. Alternatively the programs may be implemented in assembly or machine language, if desired. In any case, the language may be a compiled or interpreted language. Each such computer program may be stored on a storage media or a device (e.g. ROM or magnetic diskette), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product including a physical non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

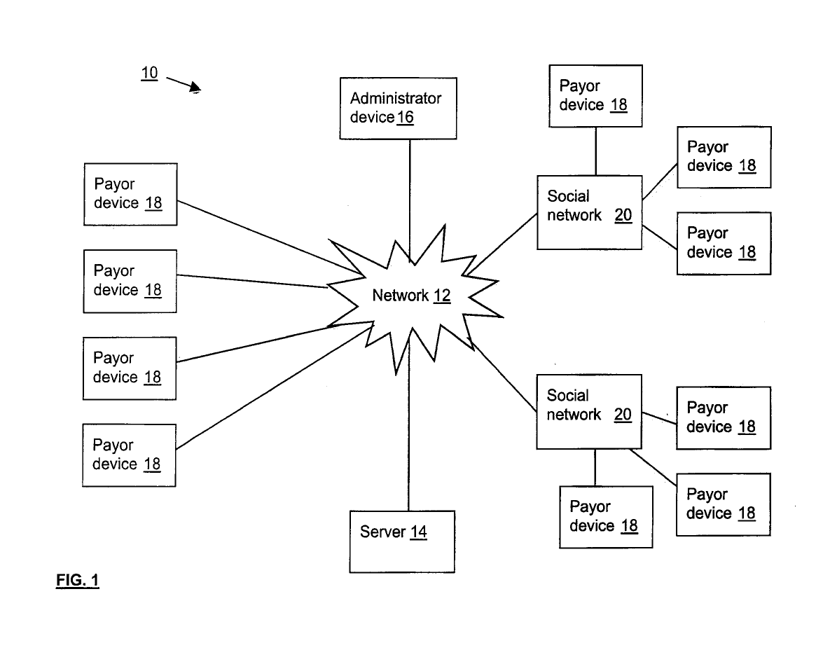

Reference is first made to FIG. 1, which illustrates a block diagram of a system 10 for managing payments in accordance with at least one embodiment. As an example embodiment, the payments may be donations, where an administrator collects donations on behalf of a recipient. System 10 includes a server 14 that connects, via network 12, to an administrator device 16 operated by an administrator, where the administrator may collect donations on behalf of a recipient. Server 14 connects, via network 12 and optionally via social network(s) 20, to one or more payor devices 18 operated by potential payors, or donors. For example, if the payments are donations then the payor devices 18 may be referred to as donor devices or donator devices operated by donors or a user who donates to the recipient.

System 10 is operable to register and validate one or more administrators operating administrator device(s) 16. Although only one is shown there may be multiple administrator devices 16 connected to system 10. System 10 is operable to collect funds for the administrator on behalf of a recipient who is need of financial aid (such as a donation recipient for example) or is otherwise collecting payments. The recipient and the administrator may have a direct or indirect relationship such that the administrator trusts that the recipient will use the raised funds honestly for the purpose the funds were collected for. System 10 is operable to provide confirmation and status update mechanisms to electronically provide notification to donors that the recipient is using the funds for the purpose they were collected for. On behalf of an administrator, system 10 sends payment requests to various potential payors operating payor devices 18. Each potential payor can use system 10 to forward the payment request to other potential payors operating payor devices 18. System 10 is operable to track and record each payment request, including the sender and recipient. Each payment request may be associated with a unique identifier. Eventually payment requests are received and acknowledged by potential payors who decide to assist and make a payment, such as a donation. A payor may provide funds to the recipient based on the relationship and implied trust between the administrator and the recipient, their own social connection to the administrator, recipient or another payor, and so on.

System 10 is operable to receive and process payments made by payors (potential payors who have provided payments). System 10 is operable to track and record each received payment request, including the associated payor, administrator and recipient. System 10 is operable to distribute received payments to the administrator who in turn distributes the funds to the recipient. System 10 is operable to receive regular status updates from the administrator. System 10 is further operable to generate electronic notifications based on the received status updates and transmit those electronic notifications to inform payors (potential payors who have provided payment) about the recipient and the recipient's use of the collected payments.

System 10 is operable to monitor the raising of funds. As part of monitoring, system 10 can send out a request for renewal of a previously made payment, or a subscription request (a request to subscribe for payments). For example, if the payments are donations then the system 10 is operable to send out a donation subscription request to receive recurring donations from a donor. System 10 is operable to update the original payment request, resend the original payment request, cancel a subscription, cancel a renewal, or otherwise cancel the collection of funds for the recipient. System 10 is operable to track and record payment details, including subscriptions and renewals. System 10 is operable to capture the relationship between the administrator and all potential payors via connected links in order to send notifications, collect rating data, collect potential payor data, recommend potential payors, generate graphs and statistics, and send status updates.

System 10 is operable to maintain a rating system by which payors can rate the administrator(s), recipient(s), other payors, and so on. An administrator and the recipient can also provide rating input to system 10. The rating feature of system 10 enables other potential payors, administrators, and recipients to review ratings and associated data that provides a measure of the reliability and trustworthiness of administrators, recipients, or other potential payors in order to further assist in deciding whether to provide payment, who to provide payments to, and who to request payments from. For example, the rating may be based on the quantity or the quality of status updates regarding the recipient and how payments have been or will be used by the recipient. As another example, the rating may be based on the amount of payments collected by an administrator for a specific recipient or an aggregate of recipients.

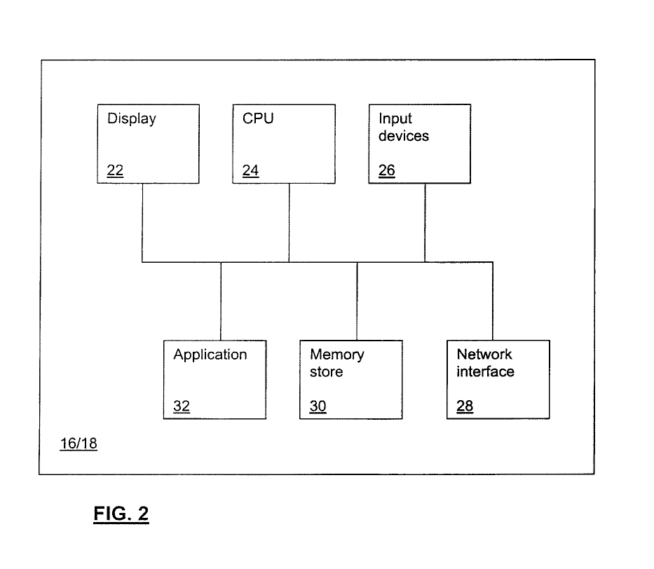

Administrator device 16 and payor devices 18 may be any networked computing device including a processor and memory, such as a personal computer, workstation, server, portable computer, mobile device, personal digital assistant, laptop, smart phone, WAP phone, an interactive television, video display terminals, gaming consoles, an electronic reading device, and portable electronic devices or a combination of these. Although for clarity only one administrator device 16 is illustrated in FIG. 1, there may be more administrator devices 16 connected via network 12. There may also be more or fewer payor devices 16 then illustrated in FIG. 1 and the payor devices may be arranged in alternative configurations. The illustrated administrator device 16 and the payor devices 18 may be different types of devices. The administrator device 16 and the payor devices 18 may include a software application, application plug-in (e.g. a widget), instant messaging application, mobile device application, e-mail application, online telephony application, java application, web page, or web object (e.g. a widget) residing or rendered on the respective administrator device 16 and payor device 18 in order to access the functionality of system 10. Administrator device 16 and payor devices 18 will be described in more detail herein in relation to FIG. 2.

Server 14 comprises one or more servers with computing processing abilities and memory such as database(s) or file system(s). For example, server 14 may include a mail server, web server, an application server and database server. Although only one server 14 is shown for clarity, there may be multiple servers 14 or groups of servers 14 distributed over a wide geographic area and connected via e.g. network 12.

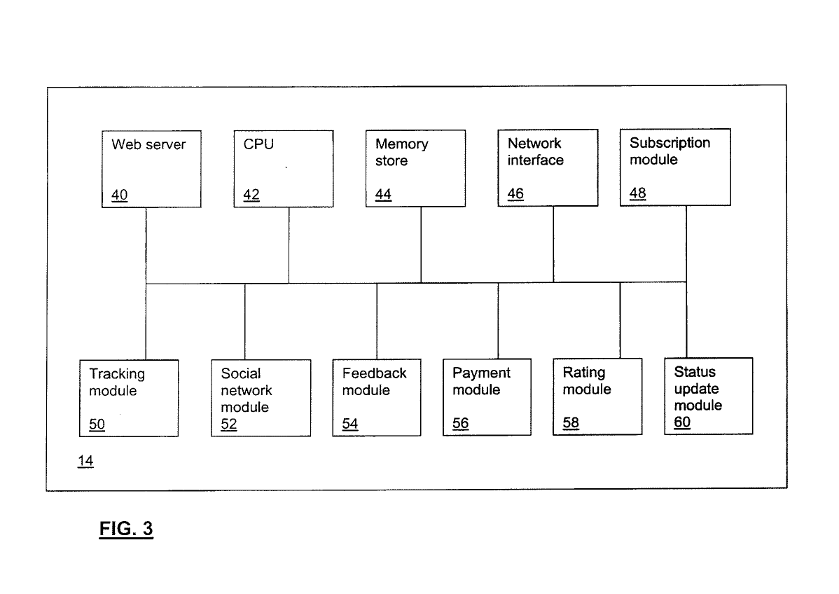

Further, server 14 may connect to one or more additional servers that provide of computational resources on demand via network 12. Server 14 will be described in more detail herein in relation to FIG. 3.

Network 12 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although not shown, administrator device 16, payor devices 18 and server 14 may connect to network 12 via a firewall, or other network security device. Firewall is a device, set of devices or software that inspects network traffic passing through it, and denies or permits passage based on a set of rules and other criteria. Firewall may be adapted to permit, deny, encrypt, decrypt, or proxy all computer traffic between network 12 and administrator device 16, payor devices 18 and server 14 based upon a set of rules and other criteria. For example, firewall may be a network layer firewall, an application layer firewall, a proxy server, or a firewall with network address translation functionality.

Social network 20 may provide an online service, platform, or site that builds electronic social networks and social relationship links between users, which may be viewed as nodes in the social network. A social network 20 may provide an electronic profile for each user, and construct a network for the user by creating electronic links to other user profiles and pages. Examples of social networks 120 include Facebook™, LinkedIn™, MySpace™, FourSquare™ and Twitter™. System 10 may also be operable to develop an internal social network 20, or a portion thereof by connecting electronic profiles of administrators, payors, and recipients, and enabling electronic communication between administrators, payors, and recipients. Social network 20 may connect administrator device 16 operated by an administrator and payor devices 18 operated by potential payors that are users of one or more social networks 20. Social networks 20 may include communication mechanisms so that users can send electronic messages to other users of the social network 20. Although two social networks 20 are shown, there may be one social network 20 or three or more social networks connected to network 12, administrator device 16, or payor device 18. Social network 20 may have an application-programming interface (API) defining functions that enable system 10 to interact with and communicate with the social network 20 and users thereof.

Reference is now made to FIG. 2, which illustrates a block diagram of an example administrator device 16 or payor devices 18 in further detail. In an exemplary embodiment, administrator device 16 or payor devices 18 have associated with them a display 22, a central processing unit 24, input devices 26, a network interface 28, a memory store 30, and a computing application 32. The display 22 may be a monitor or display screen that is used to electronically display data. The input devices 26 may be any device that allows for input, examples of which may include, but are not limited to, keyboards, microphones, speakers, and pointing devices. The central processing unit 24 is used to execute instructions for operation of the administrator device 16 or payor devices 18 and may include any type of processor, such as, for example, any type of general-purpose microprocessor or microcontroller, a digital signal processing (DSP) processor, an application-specific integrated circuit (ASIC), a programmable read-only memory (PROM), or any combination thereof. The network interface 28 may be a wired and/or wireless hardware interface that allows the device to connect to the network 12. Administrator device 16 or payor devices 18 may also include peripheral devices, such as printers, antenna, transceivers, speakers and scanners. The memory store 30 includes computer memory that is located either internally or externally to the administrator device 16 or payor devices 18 such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like. Computing application 32 may be a software application, application plug-in (e.g. a widget), instant messaging application, mobile device application, e-mail application, online telephony application, java application, web page, or web object (e.g. a widget) residing or rendered on the respective administrator device 16 and payor device 18 in order to access the functionality of system 10 and may enable administrator device 16 and payor device 18 to connect to server 14.

Reference is now made to FIG. 3, which illustrates a block diagram of a server 14 for managing payments in accordance with at least one embodiment. In an exemplary embodiment, server 14 has associated with it a web server 40, a central processing unit 42, memory store 44, a network interface 46, a subscription module 48, a tracking module 50, a social network module 52, feedback module 54, a payment module 56, a rating module 58, and a status update module 60.

The web server 40 may provide a service to administrator device 16 and payor devices 18, such as providing access to a computing application for registering an administrator, registering a potential payor, sending payment requests, receiving payments, and receiving and responding to requests received from administrator devices 16, payor devices 18, social network 20 and so on.

The central processing unit 42 is used to execute instructions for operation of the server 14 and may include any type of processor, such as, for example, any type of general-purpose microprocessor or microcontroller, a digital signal processing (DSP) processor, an application-specific integrated circuit (ASIC), a programmable read-only memory (PROM), or any combination thereof.

The memory store 44 may include any type of computer memory that is located either internally or externally to the server 14 such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like.

The network interface 46 may be a wired and/or wireless network interface that allows the server 14 to connect to the network 12. Server 14 has a network interface 46 for connecting to network 12 in order to communicate with other components, to serve web pages, and perform other computing applications. Server 14 may connect to administrator device 16 and one or more payor devices 18 via network 12, and optionally via social network 20. Although only one administrator device 16 has been illustrated, any suitable number of administrator devices 16 operated by a different or the same administrator may connect to the server 14.

Subscription module 48 is operable to configure and send payment subscription requests to potential payors. The payment subscription request may define a periodic time for making a payment for a donation, such as for example, weekly, monthly, and annually. The subscription request may not be limited to a periodic time and provide another format of recurring payments. The subscription module 48 receives payment subscription authorizations from one or more potential payors and records data identifying the payment subscription authorization in association with each of the potential payors that payment subscription authorizations were received from. A payment subscription record may include a unique identifier for identifying the record, a payor name, an amount, an administrator, a recipient, a time stamp, a data stamp, an expiry date, a payment period, and so on.

As an example, at the expiry of a periodic time for donating, the subscription module 48 is operable to validate that a subscription is about to expire and send an automated request to renew the subscription to the administrator. System 10 is then operable to resend a payment request to, or automatically receive a payment from, each of the one or more potential payors that payment subscription authorizations were received from. The administrator can also reject the renewal of a subscription and cancel the payment request. The system 10 updates and stores this information. The administrator device 16 can access system 10 in order to change the value of the requested payment and the structure or format of the payment before resending.

Subscription module 48 is operable to send requests to payor devices 14 for renewal of a previously made payment, and receive authorizations for the renewal request from payor devices 14, which may in turn result in receipt of another payment. For example, at the expiry of a periodic time for donating, the subscription module 48 is operable to validate that a payment renewal request should be sent to one or more potential payors. System 10 is then operable to send a payment renewal request to, or automatically receive a payment for a payment from, each of the one or more potential payors.

Subscription module 48 is operable to receive financial information from a payor device 14 that a payment subscription authorization or renewal authorization was received from, such as a credit card account, bank account, electronic payment account identifier, and so on. In accordance with some embodiments, at each occurrence of the periodic time for donating, subscription module 48 is operable to automatically initiate and process a payment for a donation for the payor using the stored financial information. Subscription module 48 may process the payment by interacting with the third party payment processor, for example. Subscription module 48 is further operable to send a confirmation to each payor once the automated payment is processed. Subscription module 48 is further operable to send a payment reminder to each of the one or more potential payors payment subscription authorizations were received from at each occurrence of the periodic time for donating, or prior to.

Tracking module 50 is operable to track connections between administrators, recipients, and potential payors by storing links between administrators, recipients, and potential payors. For example, server 14 receives a confirmation that one or more payment requests were sent from an administrator to potential payors over one or more networks, where the one or more payment requests are associated with the recipient. In response, tracking module 50 stores a link between the administrator, the recipient, and each potential payor in a database. Further, server 14 receives a confirmation that one or more payment requests were sent from a payor to one or more other potential payors over a network, where the one or more payment requests are also associated with the recipient. In response, server 14 stores a link between the potential payor and each potential payor that a payment request was sent to in the database. Tracking module 50 tracks the connection between all potential payors that received a payment request associated with the recipient, as well as the administrator and the recipient. For example, for each payment request sent, tracking module 50 is operable to store the sender, the recipient, when it was sent, how many times a payment request was sent by the sender, how many times a payment request was received by a recipient, whether a payment was received in association with the payment request, how many times a recipient has donated, how many times the sender has sent a payment request to a given recipient, and so on. Further, if payments for the recipient are received by system 10, tracking module is operable to store data identifying the received payment in association with the corresponding payor, in order to track how many times the payor has made a payment for that recipient or other recipients, how many times the payor has made a payment in relation to receiving a request from a specific administrator or other potential payor, how many times the payor has received a payment request, and so on. Tracking module 50 maintains, in memory store 44, a record of links between an administrator, recipient, and potential payors in order to send notifications of received payments and status updates, as well as receive rating indicia and feedback from payors in relation to an administrator, a recipient, or other potential payors. Tracking module 50 is further operable to generate statistic and reports based on the data collected and stored in memory store 44 regarding administrators, recipients, payors, received payments, and so on.

Social network module 52 is operable to interact with social network 20 using an API for the social network 20. For example social network module 52 is operable to receive a confirmation that a payment request sent to a potential payor via social network. The confirmation may include the sender, the recipient, the recipient, the time and date, and other information. As another example, social network module 52 is operable to send payment requests between users (potential payors) of the social network 20, and store data indicating that payment requests were sent over social network 20 or network 12.

Feedback module 54 is operable to send requests for feedback in relation to an administrator, a recipient, potential payors, or a combination thereof. The requests for feedback may accompany notifications, status updates, or other communications. Feedback module 54 is operable to receive feedback indicia in response to the request for feedback. Feedback module 54 is operable to interact with rating module 58 to compute a rating for an administrator, a recipient, and potential payors based on the one or more received feedback indicia.

Payment module 56 is operable to receive one or more payments for the recipient from one or more potential payor devices 18. Payment module 56 is operable to receive financial information from a payor device 18 and process a payment.

Payment module 56 is operable to connect to a third party payment processor in order to process the payment. Payment module 56 is operable to store data identifying received payments in association with the corresponding payor, the administrator, and the recipient. Payment module 56 is operable to calculate a total of all received payments for a particular recipient or administrator, and provide a total payment to the administrator who is collecting payments on behalf of the recipient.

Rating module 58 is operable to receive rating indicia for an administrator, a recipient, potential payors, or a combination thereof, from one or more potential payors, and so on. Rating module 58 is operable to compute a rating for the administrator, a recipient, potential payors, or a combination thereof, using the rating indicia. Rating module 58 is further operable to store the computed rating in association with the corresponding administrator, recipient, and potential payors. Rating module 58 may display the rating, include the rating in a payment request, send the rating to all potential payors that received a payment request in association with a given administrator or recipient, display the rating, and so on. That rating provides a mechanism by which payors can rate each other, an administrator, or the recipient, so that other potential payors can review ratings and associated data that provides a measure of the reliability and trustworthiness of administrators, recipients, or other potential payors in order to further assist in deciding whether to donate, who to donate to, and who to request payments from.

As an example, the rating indicia may be based on the total amount of payments collected by the administrator from potential payors. An administrator may provide status updates in relation to the recipient to communicate to potential payors the results of received payments, such as how the recipient has used the collected payments. The rating indicia may include a rating of received status updates, such as for example, the quality of the status update, the quantity of status updates, verification of the status updates, and so on. The rating indicia may include feedback indicia received from the feedback module 54. As another example, system 10 may receive a list of potential payors that know the recipient. System 10 is operable to prompt the administrator to send a payment request to those potential payors that know the recipient. System 10 is further operable to send a feedback request to those potential payors that know the recipient in order to collect feedback indicia about the recipient for provision to the rating module 58 in order to determine a rating for the recipient. System 10 is further operable to send a feedback request to those potential payors that know the recipient in order to collect feedback indicia about the administrator for provision to the rating module 58 in order to determine a rating for the administrator.

Rating module 58 is further operable to provide to the administrator, recipient, and potential payors an option of opting out of a rating. In response to receiving confirmation that one or more of the administrator, recipient, and potential payors desire to opt out of a rating then the rating module 58 may be configured to not display or otherwise provide the rating for the administrator, recipient, and potential payors that wanted to opt out. However, even in such circumstance the rating module 58 may still compute a rating for the administrator, recipient, and potential payors that wanted to opt out.

Status update module 60 is operable to receive a status update message associated with the recipient from the administrator. For example, the status update message may indicate that the collected payments have been distributed to the recipient, the amount of the total payment collected by the administrator on behalf of the recipient, how the payment has been used by the recipient, the current status of the recipient, and so on. For example, the payments may be donations provided to the recipient for school tuition and a status update message may indicate that the recipient has started school. Another status update message may indicate what courses the recipient is taking, and a further status update message may indicate grades obtained by the recipient in those courses. The status update module 60 is operable to forward the status update message to payors that payments were received from, or all potential payors that received a payment request, for example.

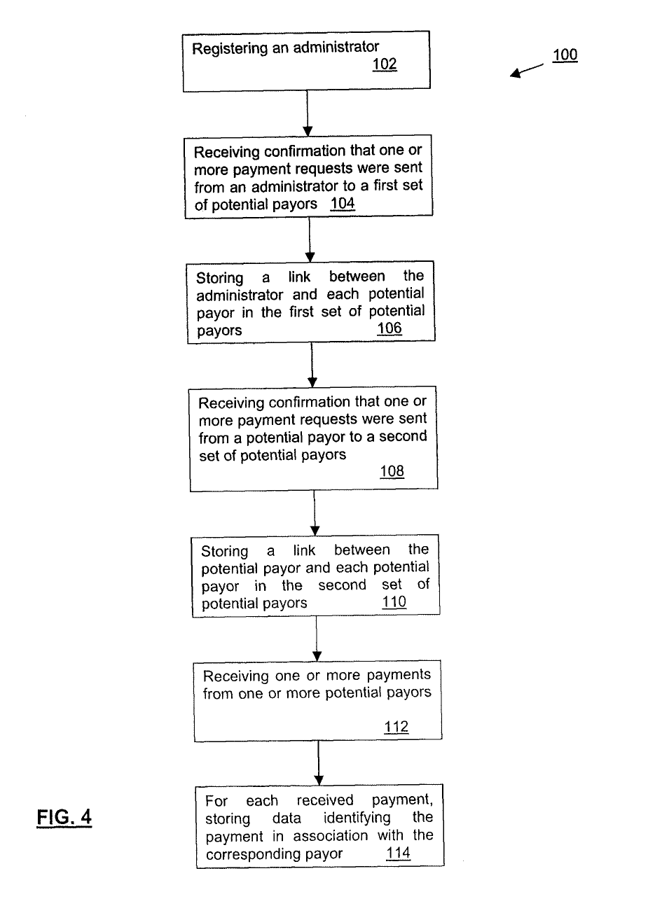

Referring now to FIG. 4, there is shown a flowchart diagram of a method 100 for managing payments in accordance with at least one embodiment. The method will be described in the context of an example embodiment where the administrator collects/solicits donations from donors on behalf of the recipient.

At step 102, system 10 registers an administrator in a database. The administrator collects/solicits donations on behalf of one or more recipients. The administrator may have a direct or indirect relationship with the recipients to reduce the level of anonymity and generate a level of trust. To register the administrator, system 10 is operable to create an account to receive and record administrator details, such as a username, name, address, email address and so on. System 10 also records details about the specific payment collection, such as information about the recipient in order for the administrator and system 10 to collect donations on behalf of the recipient. System 10 records further configuration details about the donation collection, such as the reason or cause for the donation collection, the desired total amount, deadline and so on. System 10 enables an administrator to collect donations on behalf multiple recipients and on behalf of the same recipient but for different reasons or causes. System 10 is operable to register multiple administrators to collect donations on behalf of multiple recipients. Different administrators may collect donations on behalf of the same recipients, and the same administrator may collect donations on behalf of different recipients. Donation collection may be restricted for some administrators and recipients, depending on their rating or the amount of donation requested for example. The restriction may be on the number of recipients a single administrator may collect donations on behalf of, the amount of donations that may be collected, or the number of donors, for example. Administrator data may be stored by system in an administrator record.

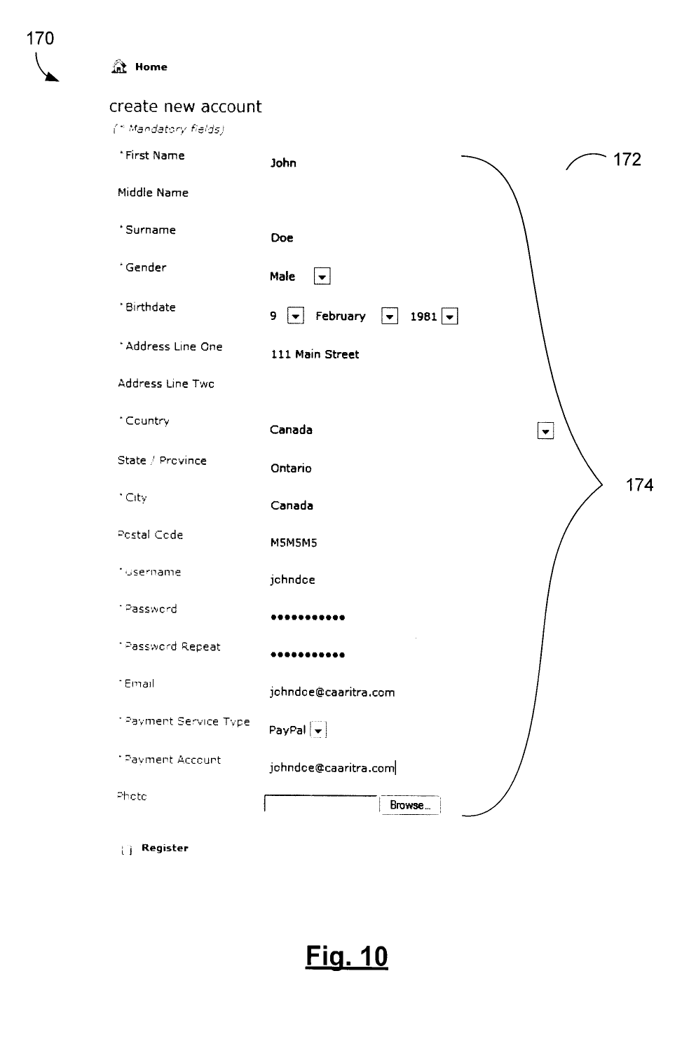

Referring now to FIG. 10 there is shown an interface 170 for registering an administrator. System 10 is operable to provide an interface 170 with an administrator account page 172 for receiving data about the administrator in order to register the administrator at 102 of FIG. 4 and create and store a record for the administrator in memory store 44. The administrator account page 172 includes various fields 174 for receiving administrator data. Example fields include first name, middle name, surname, gender, birthdate, address, country, state/province, city, postal code, username, password, email, payment service type (e.g. PayPal, credit, debit, email transfer), payment account reference, photo, and so on. System 10 is operable to store the received administrator data as part of the administrator record in memory store 44. Some of the fields 174 may be mandatory fields. The administrator record may be subsequently updated using administrator account page 172. System 10 is operable to verify the received fields 174. For example, system 10 is operable to verify an email address by sending an email and receiving confirmation. Further, system 10 is operable to receive a file identifying the government ID for the administrator via upload, or other file transfer mechanism. System 10 is operable to verify the administrator using the received government ID.

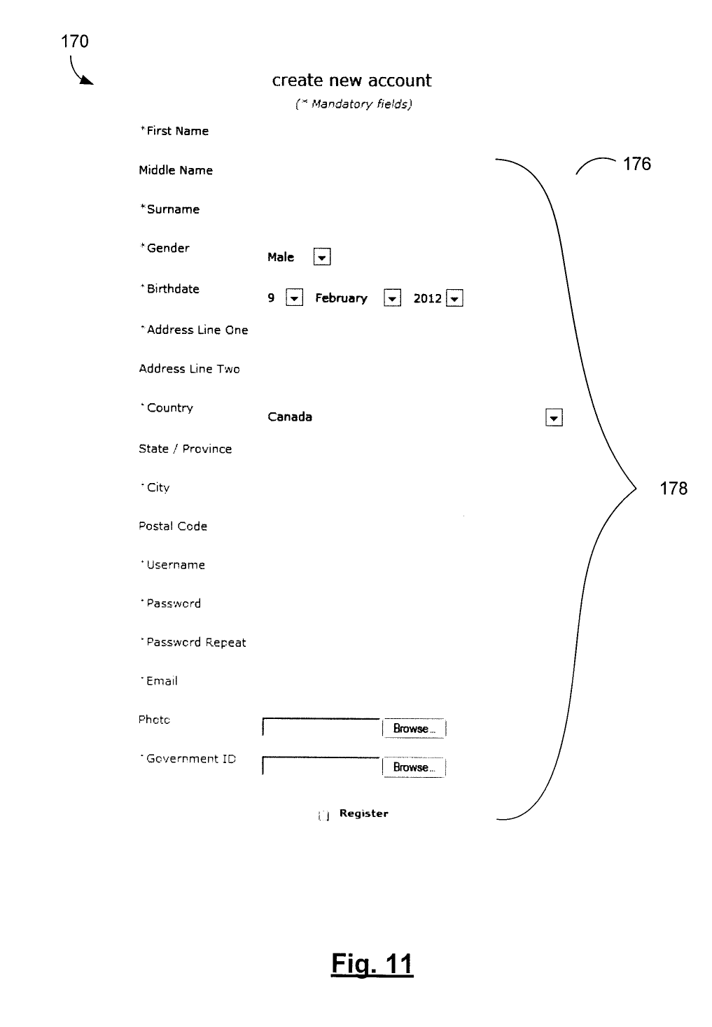

System 10 is further operable to register a recipient that the administer collects donations on behalf of. Referring now to FIG. 11 there is shown an interface 170 for registering a recipient for the collection donations. System 10 is operable to provide an interface 170 with a recipient account page 176 for receiving data about the recipient in order to register the recipient, and create and store a record for the recipient in memory store 44. The recipient account page 176 includes various fields 178 for receiving recipient data. Example fields include first name, middle name, surname, gender, birthdate, address, country, state/province, city, postal code, username, password, email, photo, government ID and so on. System 10 is operable to receive a file identifying the government ID via upload, or other file transfer mechanism. System 10 is operable to verify the recipient using the received government ID. This may reduce fraud and fraudulent collection of donations. System 10 is operable to store the received recipient data as a recipient record in memory store 44. Some of the fields 178 may be mandatory fields as a further attempt to reduce fraud. For example, system 10 is operable to verify the email address by sending a verification message to the email and receiving a confirmation. Further, system 10 may check to ensure the recipient email is not the same as the administrator email. The recipient record may be subsequently updated using recipient account page 176.

As noted, system 10 is operable to verify the recipient using the received government ID. This may reduce fraud and fraudulent collection of donations. System 10 is operable to verify or validate the government ID of the recipient. Referring now to

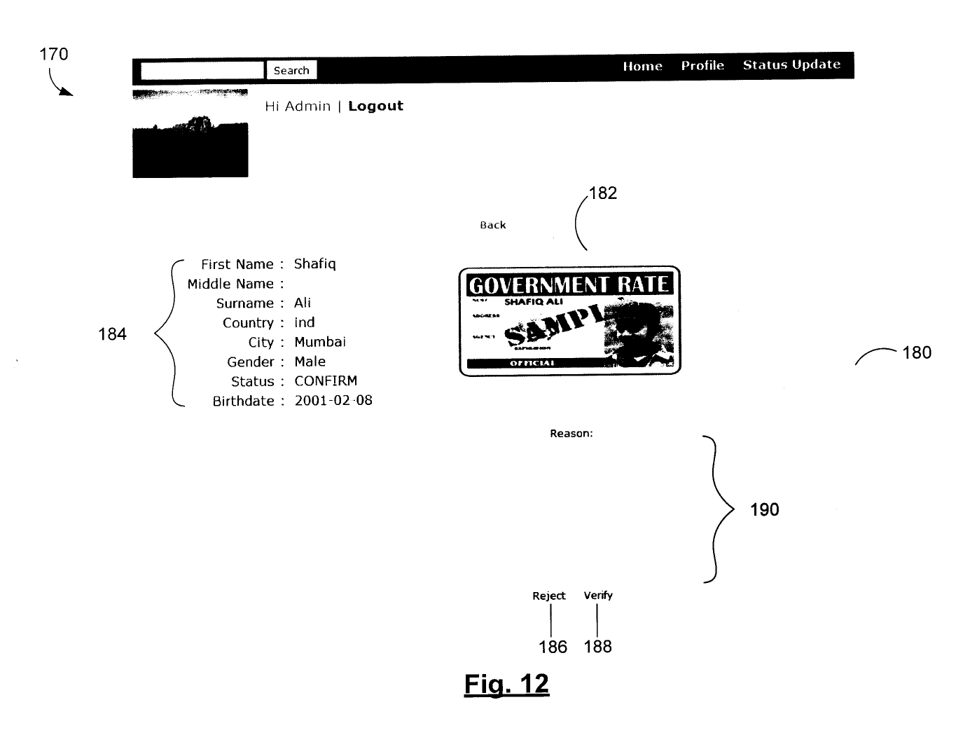

FIG. 12 there is shown an interface 170 providing a recipient verification page 180. Interface 170 may be used by a customer service representative of system 10 to verify the government ID. The recipient verification page 180 may display a representation of the received government ID 182, recipient data 184, a rejection button 186, a verify button 188, and a reason text box 190. A customer service representative may review representation of the received government ID 182 and compare it to the received data in order to verify the recipient. System 10 may also communicate with one or more government systems in order to verify the government ID. For example, system 10 may submit a verification request to a government system for authentication, where the verification request includes a copy of the government ID, and receive a confirmation or rejection in response from the government system. As a further example, system 10 is operable to connect to government system to automatically compare a copy of the government ID to a database of government ID to find a match. The customer service representative can provide an indication of verification to system 10 via a verification button 188 and an indication of a rejection to system 10 via a reject button 186.

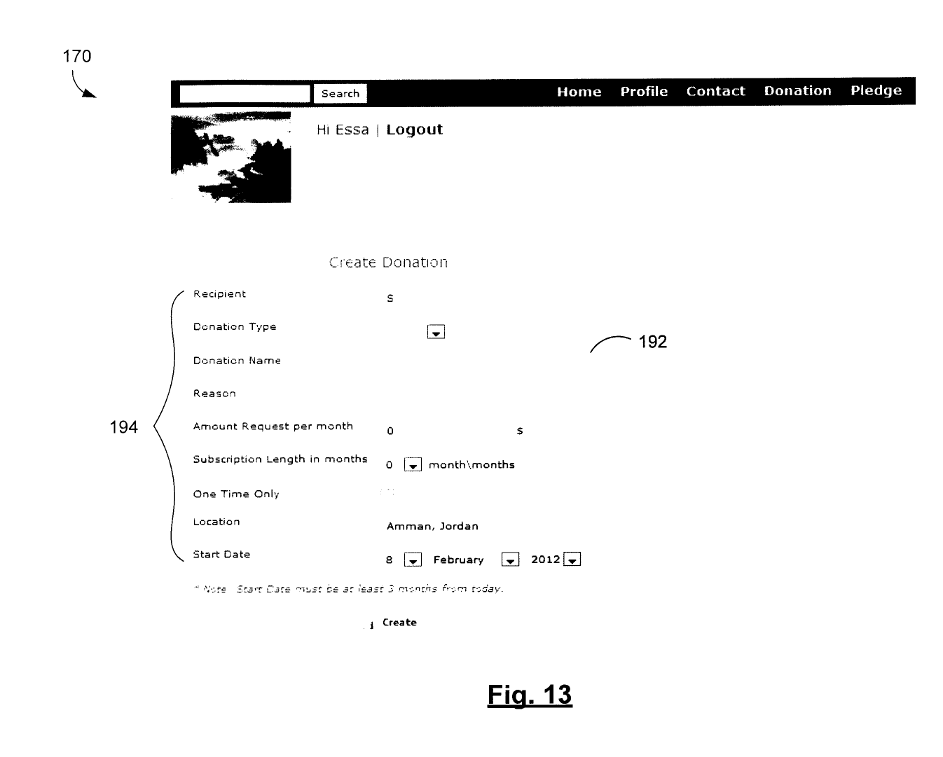

Referring now to FIG. 13 there is shown an interface 170 for creating a donation request profile page 192 for collecting donations on behalf of a recipient. The donation request profile page 192 includes various fields 194. The various fields and corresponding values configure the specific donation. For example, the fields 194 may include recipient, donation type, donation name, reason, amount request per month, subscription length in months, one time only, location, start date, end date, and so on. These are examples only and other fields may be used to configure the specific donation. The values associated with the fields 194 may be modified and updated. Each specific donation may have a corresponding donation request profile page 192. The data collected in association with the fields of the donation request profile page 192 may be saved in a donation record in memory store 44. There may be a donation record for each donation managed by system 10. The donation record may be identified by a donation record identifier and modifications thereto may be tracked by system 10. In accordance with some embodiments, the fields 194 may have mandatory values and system 10 may verify or check the values before storing them in the donation record. For example, the recipient field may require the name of a registered recipient. If the provided recipient name is not associated with a recipient record then system 10 may prompt with an error message, or the like. This may help prevent fraud as only registered recipients may be the subject of a donation request. As noted herein, registered recipients are verified, such as by checking an associated government ID for example.

System 10 is operable to send donation requests to potential donors on behalf of the administrator. System 10 is operable to manage a set of contacts on behalf of the administrator. The set of contacts may in turn by used to efficiently generate a set of potential donors that donation requests will be sent to. System 10 is operable to maintain a database in memory store 44 of potential donors, each donor being associated with a donor record. System 10 is operable to provide a search interface for an administrator in order to receive a search string and provide a list of potential donors matching the search string. An administrator may use system 10 to add as contacts potential donors maintained in donor records.

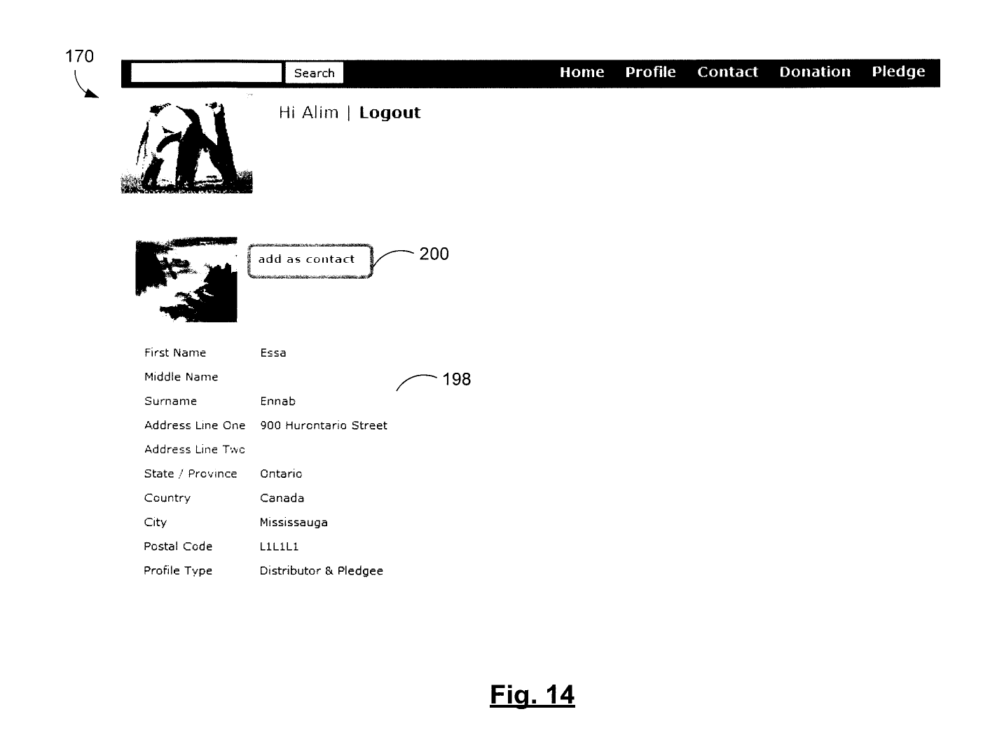

Referring now to FIG. 14 there is a shown an interface 170 displaying a donor record page 198 and data regarding the donor. System 10 is operable to display the donor record page 198 in response to a search string. For example, an administrator may search for a donor named “Essa” and system 10 may return a donor record page 198 associated with a donor named “Essa” in response. System 10 is operable to provide an add as contact button 200 as part of interface 170 in order to enable an administrator to add a donor associated with a donor record as a contact. The administrator can then send donation requests to contacts of his/her set of contacts. System 10 is operable to create a link between an administrator record and the donor record when the administrator adds a donor as a contact. In accordance with some embodiments, prior to adding a donor as a contact, a verification message may be sent to the donor requesting confirmation that the administrator may add them as a contact.

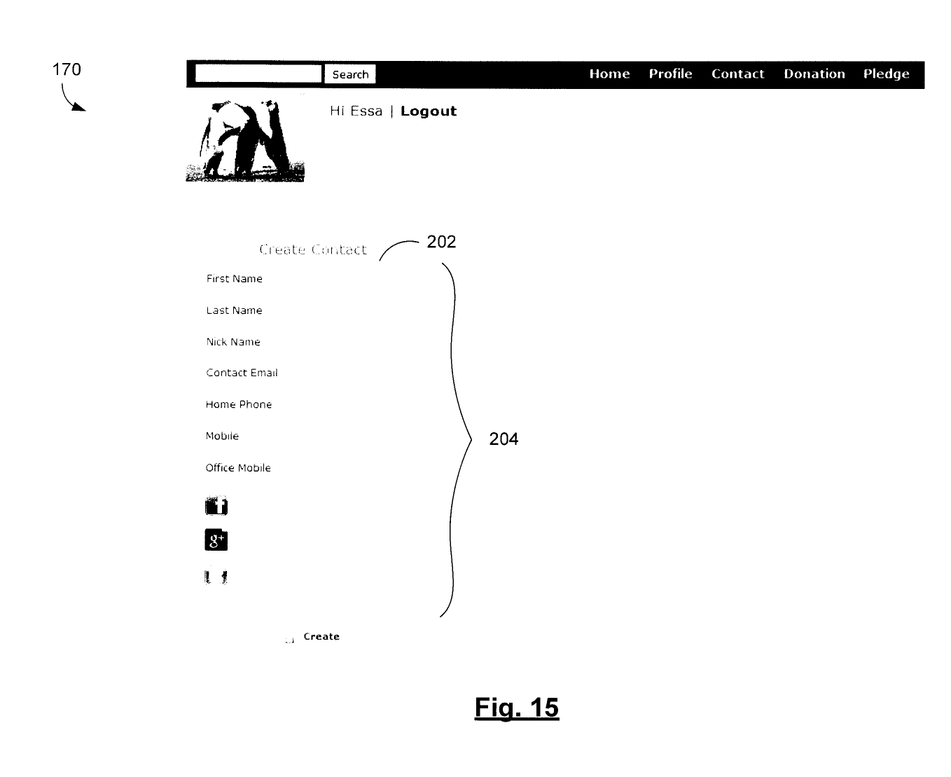

Referring now to FIG. 15 there is shown an interface 170 for adding a new contact to system 10. For example, an administrator may want to add as a contact a potential donor that is not already associated with a donor record maintained by system 10. Accordingly, system 10 is operable to provide a create donor page 202 with various fields 204 for receiving data values for donor record, which will be stored by system 10 in memory store 44. For example, the various fields 204 may include first name, last name, nick name, contact email, home phone, mobile, office mobile, social network username, third party service username, and so on. The values will be stored by system 10 in a donor record in memory store 44 and may be subsequently edited/modified. System 10 is operable to detect which administrator created a donor record, and add the donor to his/her set of contacts by linking the donor record to the administrator. In accordance with some embodiments, a potential donor may create their own record for searching by administrators, or a subset of administrators. For example, a donor may specify that their record is only visible to administrators with certain rating level.

System 10 is further operable to create a set of contacts for an administrator by importing contact books, such as a contact book maintained on a mobile phone, social network, third party service, and so on. Accordingly, an administrator can manually add to his/her set of contacts donors already maintained by system 10, new donors not already maintained by system 10, contacts from existing imported contact books, and so on.

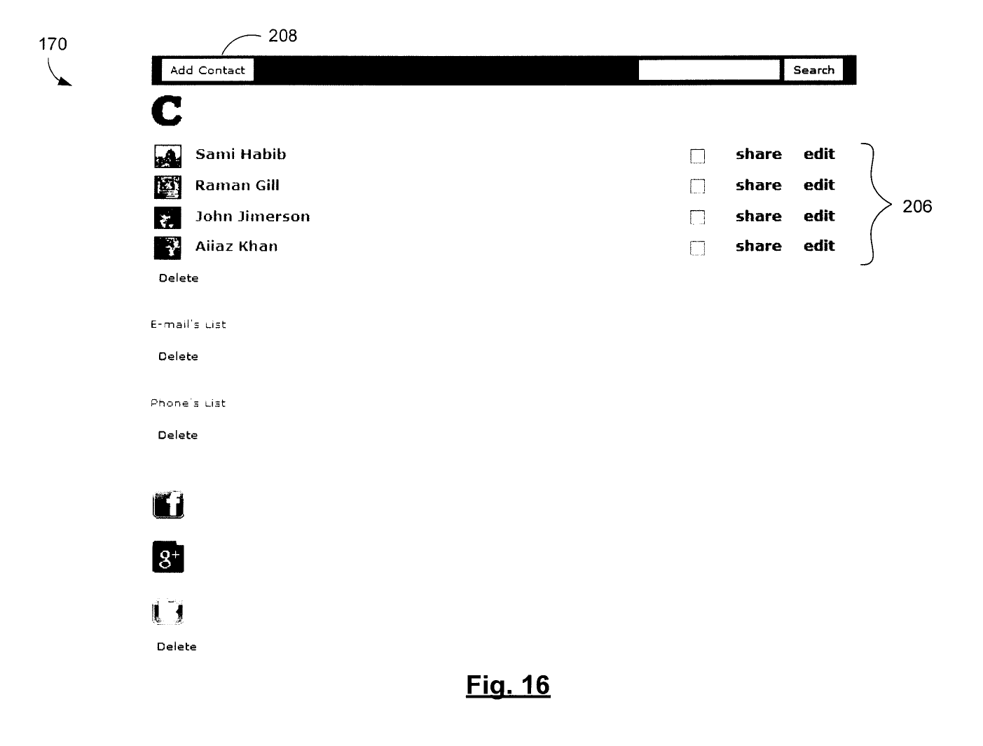

Referring now to FIG. 16 there is shown an interface 170 displaying a set of contacts 206 for a specific administrator. System 10 is operable to enable sharing of one or more contacts, editing data of one or more contacts, and so on. System 10 is further operable to add a new contact via an add contact button 208.

Referring back to FIG. 4, at step 104, system 10 receives a confirmation that donation requests were sent from the administrator to a first set of potential donors over one or more networks 12, where the one or more donation requests are associated with a recipient. In accordance with some embodiments, the first set of potential donors may be viewed as a subset of one or more contacts of the set of contacts associated with the administrator. As described herein, each donation program maintained by system 10 is associated with a recipient, as defined by the associated donation record.

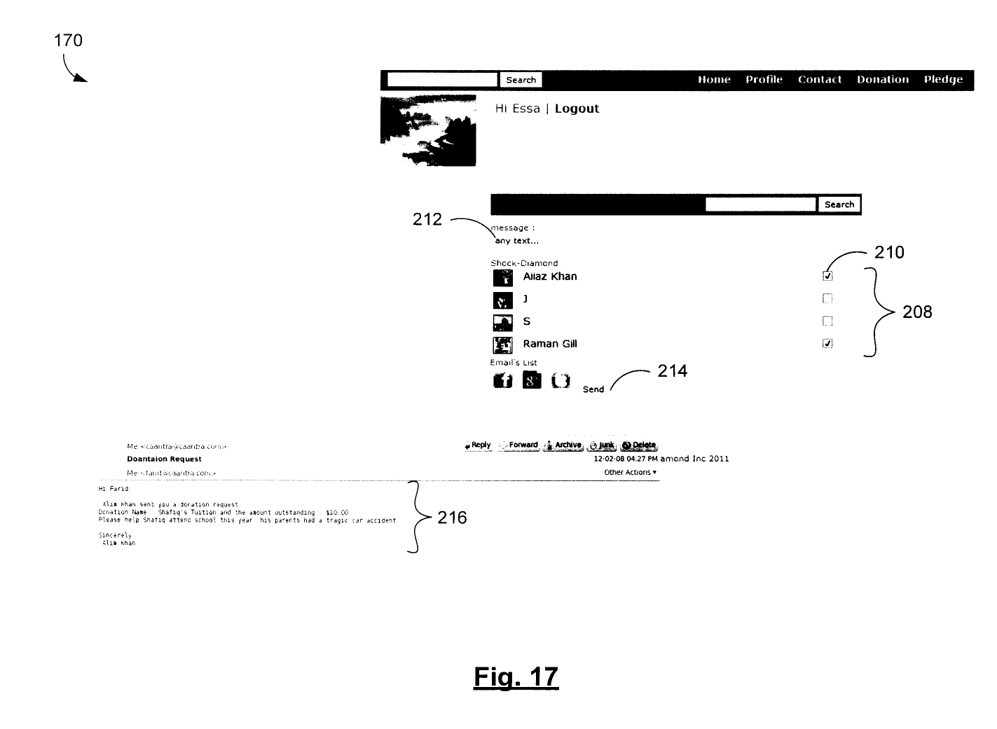

Referring now to FIG. 17 there is shown an interface 170 for sending donation requests to potential donors. The interface 170 displays a set of contacts 208 for the administrator and selection boxes 210 indicating whether a donation request should be sent to specific contact. The contacts of the set of contacts 208 with the selection box 210 activated may be referred to as the set of potential donors for the specific donation program. The interface 170 may provide a text box 212 for customizing the message of the donation request. The interface 170 may also provide a send button 214 to activate sending of the donation request. There is also shown a sample donation request 216 indicating the administrator of the donation program, the name of the donation, the recipient, the donation amount requested, the reason for the donation request, the donation amount outstanding, and a link to activate a donation payment. In accordance with some embodiments, the donation request is an electronic message that is sent to an electronic address, such as an email or mobile phone number, associated with the potential donor.

System 10 is operable to send donation requests from the administrator to potential donors. For example, system 10 may retrieve an electronic address (such as an email address or mobile phone number for example) for each potential donor. System 10 is operable to send a donation request on behalf of the administrator to each electronic address on the list of potential donor. System 10 may configure the donation request for each potential donor or may send a default donation request to all potential donors.

System 10 is operable to interface with a social network 20 to send donation requests. System 10 is further operable to receive confirmations that donation requests were sent over a social network 20 using an API for the social network 20. For example, the administrator may initiate the sending of the donation request using a messaging feature of a social network 20. System 10 is operable to make a function call using the API for the social network 20 to receive a confirmation that a donation request was sent from an identified sender to an identified recipient (potential donor).

Each donation request may contain a software application configured to identify the sender and receiver of the donation request. For example, if a donation request was sent from the administrator to potential donor A, then the software application in the payment request is configured to provide a confirmation to system 10 identifying administrator as the sender and potential donor A as the recipient. Further, if the payment request was then sent from potential donor A to potential donor B, then the software application in the payment request is configured to provide a confirmation to system 10 identifying potential donor A as the sender and potential donor B as the recipient.

The payment request may be a request for a lump sum donation of an amount lesser or equal to a total desired donation amount. The payment request may also include a donation subscription request that defines a periodic time for donating or a donation renewal request that defines a time for re-donating. For example, the donation subscription request may request a donation of $10 every month. System 10 is operable to receive donation subscription authorizations from one or more potential donors to authorize the donation subscription request. System 10 records data identifying the donation subscription authorization in association with the donor records of each of the one or more potential donors that donation subscription authorization was received from, as well as in associated with the donation record. At each occurrence of the periodic time for donating, system 10 is operable to send a donation request or reminder to each of the one or more potential donors payment subscription authorizations were received from. System 10 may also automatically process a donation at each time for donating using stored financial data.

In accordance with some embodiments, for each received confirmation that one or more donation requests were sent, system 10 is operable to receive and store a date and time of each donation request, as well as other meta data about the donation request. System 10 is operable to compute data relating to donation requests. For example, system 10 is operable to determine and store a number of times a donation request was sent to each potential donor, a number of times each potential donor sent a payment request, and so on.

At step 106, system 10 stores a link between the administrator and each potential donor of the first set of potential donor (those potential donors that received a payment request from the administrator) in the database. System 10 is operable to store links between the administrator record and donor records for all potential donors that the administrator sent a donation request to in order to manage the donation collection and track all potential donors who received donation requests associated with the recipient.

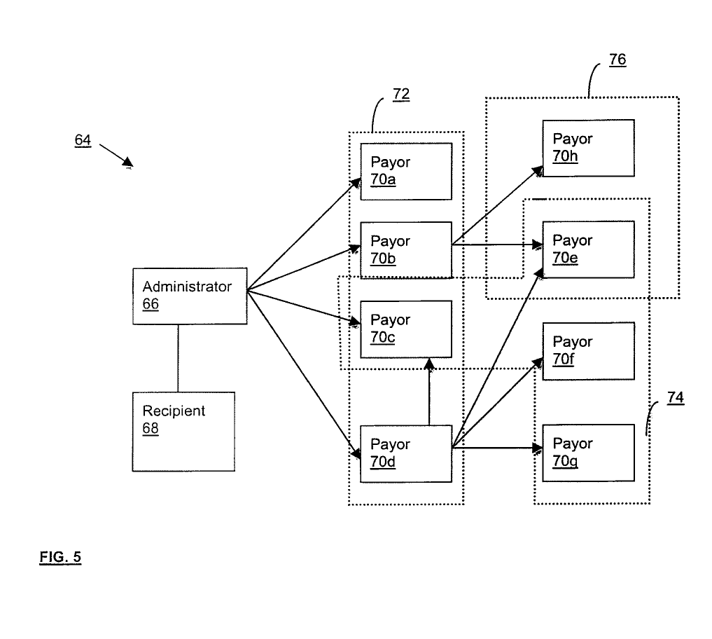

Referring now to FIG. 5, there is shown a schematic diagram of a graph 64 illustrating links between the administrator 66 and potential donors 70 in accordance with at least one embodiment. System 10 stores a link or mapping between administrator 66 and the donor 68. System 10 stores a link between the administrator 66 and potential donors 70a, 70b, 70c, 70d of a first set of potential donors 72.

System 10 is operable to configure the donation requests based on the received configuration details about the donation collection. For example, the donation request may identify the recipient, the administrator, the reason or cause for the donation collection, the desired total amount, the deadline for providing donation, and so on. The payment request further includes indicia for submitting a donation or viewing further details about donation, such as a “pay now” or “donate now” button, or a “more details” button.

At step 108, system 10 receives a confirmation that donation requests were sent from a potential donor of the first set of potential donors to a second set of potential donors over one or more networks 20, where the donation requests are associated with the recipient. That is, a donor that receives a donation request can forward or send the donation request to one or more other potential donors. In accordance with some embodiments, for each received confirmation that one or more donation requests were sent, system 10 is operable to receive and store data associated with the donation request, such as the date and time of the donation request, for example. The data may be stored in a donor record, donation record, and so on. System 10 is operable to compute data relating to donation requests, such as a number of times a donation request was sent to a particular potential donor. Accordingly, system 10 is operable to update a donor record each time the associated donor receives a donation request. System 10 can directly send a donation request from a potential donor to another potential donor, or system 10 can interact with social network 20 to receive a confirmation that a payment request was sent over the social network 20. A donation request can also include a software application configured to automatically send a confirmation to system 10 when a donation request is sent, along with other data such as the sender and the recipient of the donation request.

At step 110, system 10 stores a link between the potential donor of the first set of potential donors and each potential donor of the second set of potential donors in the database. Referring back to FIG. 5, system 10 stores a link between potential donor 70b of a first set of potential donors 72 and potential donors 70h, 70e of a second set of potential donors 76. A potential donor 70d of the first set of potential donors 72 sends a payment request to another potential donor 70c of the first set of potential donors 72, along with other potential donors. System 10 stores a link between potential donor 70d and potential donors 70c, 70e, 70f, 70g of another set of potential donors. Accordingly, a potential donor 70c may form part of two different sets of potential donors 72, 74. A potential donor 70e may receive multiple payment requests from different potential donor 70b, 70d, and that potential donor 70e may also form part of two different sets of potential donor 74, 76. System 10 may implement steps 108 and 110 whenever donation requests are sent to potential donors.

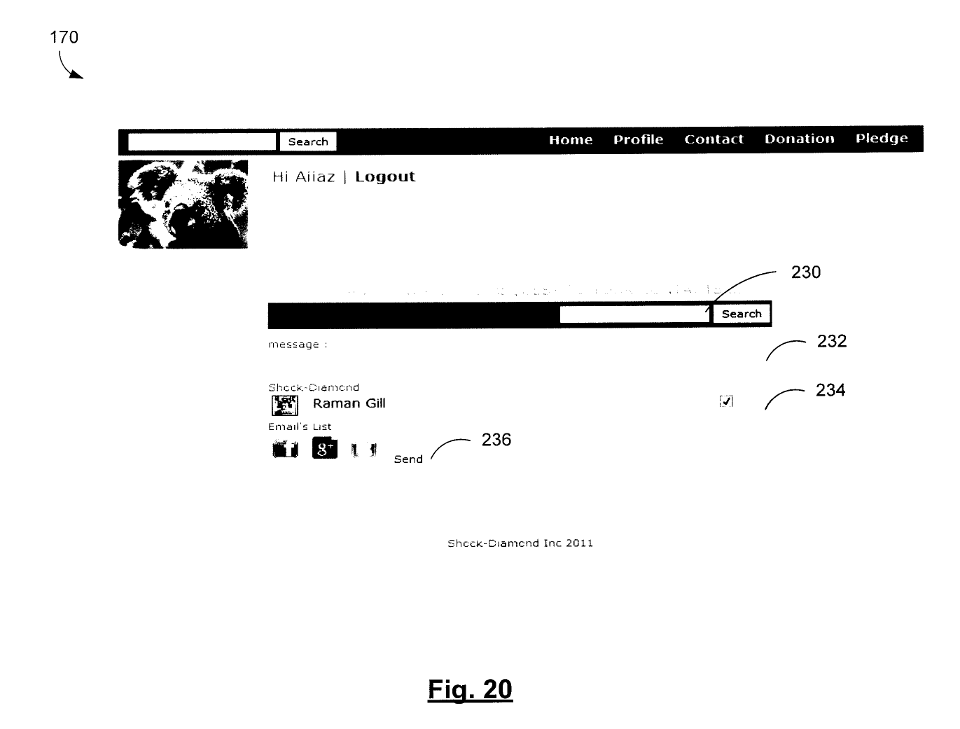

Referring now to FIG. 20 there is shown an interface 170 for forwarding donation requests to additional potential donors. The interface 170 may provide a list of contacts associated with the donor that received the donation request. The interface 170 may also provide a search box 230 to search through a database of potential donors accessible to the donor that received the donation request. That way, if a potential donor is not able to make a donation he/she can forward it to someone else that may be in a position to make a donation. A potential donor who made a donation can also forward the donation request on. For example, the donor may have made a donation that only partially covered the outstanding donation total and so he/she may forward the donation request to other potential donors to help attain the donation total. The interface 170 may provide a message box 232 so that the donor who received the donation can personalize the forwarded donation request with a message. The interface 170 may provide a selection box 234 to select a contact to send the donation request to from a list of contacts associated with the donor, and a send button 236 to forward to donation request. Forwarding donations enables an administrator to indirectly leverage the social network and contacts of potential donors who have received donation requests. In accordance with some embodiments, a donor may create an account with system 10 to manage donation requests and contacts, as a specific donor may receive multiple donation requests associated with the same or different donation programs, recipients, administrators and so on. After the donor logs in, then system 10 may display a listing of all pending donation requests that the donor can either accept, reject or forward. The donor can also create a set of contacts as described herein in relation to the administrator and the donor can forward the donation request to an electronic address associated with one or more contacts, or another electronic address.

At step 112, system 10 receives one or more donations for the recipient from one or more potential donors. The potential donors may have received a donation request that contains an embedded software application for receiving payment. The donation request may have also contained a link, such as a uniform resource locator, for accessing system 10 and interface 170 in order to make a donation. The donation request may include donation indicia, such as a “donate now” button. A potential payor may click on the donation indicia which may activate access to system 10 via a payment portal or interface 170 so that system 10 can receive the donation and payment details for processing the donation. System 10 may interface with a payment processor in order to process the donation. In accordance with some embodiments, system 10 may prompt a potential donor to register prior to submitting a donation, such as is described in relation to an administrator or recipient for example. System 10 may register a potential payor by receiving details such as user name, password, address, email address, and so on, and storing the received details in a database. If system 10 has previously registered a potential payor then system 10 may prompt the potential payor to log into system 10 using their username and password, for example.

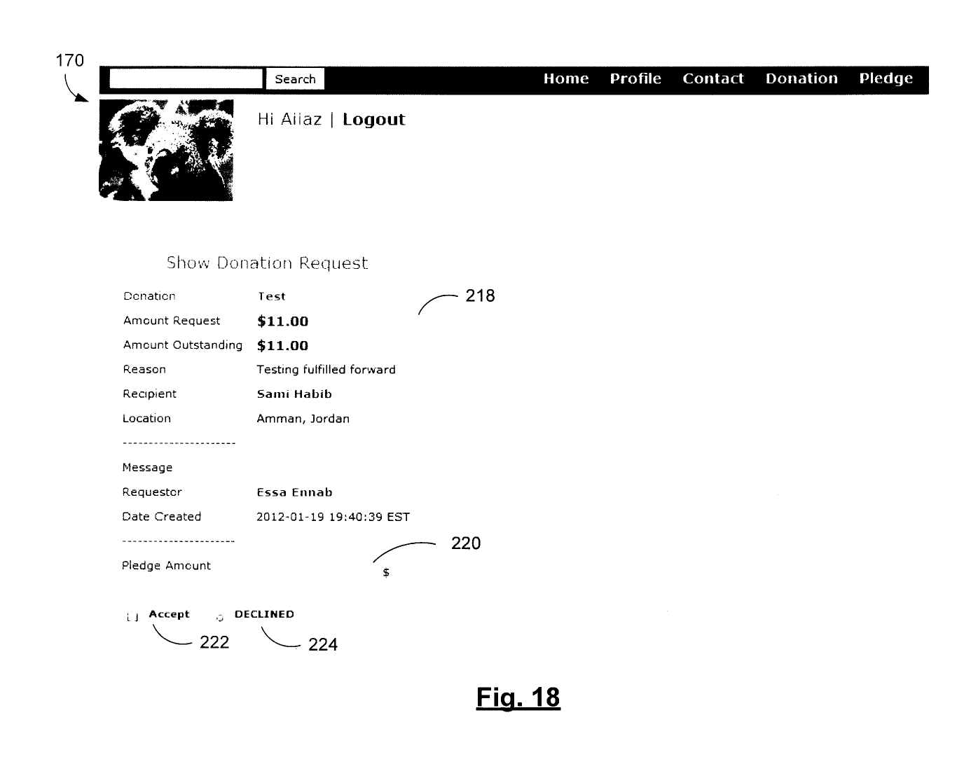

Referring now to FIG. 18, there is shown an interface 170 displaying a donation request response page 218 to enable a donor to respond to a received donation request. The donation request response page 218 displays various data about the donation program and specific donation request, such as the donation name, amount requested, amount outstanding, reason, recipient, location, message from administrator, administrator (or requestor if forwarded from another potential donor), date created. The donation request page 218 further includes a text box 220 for entering an amount to donate, and a accept button 222 to activate payment of the donation amount, and a decline button 224 to decline the donation request. When a donor activates the accept button 222 the interface 170 may provide or connect to a payment gateway to process payment for the donation. System 10 is operable to record in the donor record details about the response to the donation request, such as for example an acceptance and decline, donation amount, and so on.

FIGS. 18 and 20 illustrate interfaces 170 that may be provided to any of the potential donors that received donation requests, such as the potential donors of the first or second set of potential donors, or third, fourth, and so on.

A potential donor may receive multiple donation requests from different sources for the same donation program. When the potential donor responds to one of the donation requests then system 10 automatically applies the same response to all pending donation requests related to that potential donor and the donation program so that the donor only needs to respond to one of them.

System 10 is operable to receive financial data from potential payor in order to receive a donation, such as a credit card account number, electronic account information, bank account number and so on. System 10 is operable to process the payment using payment module 56, or optionally by interacting with a third party payment gateway or payment processor. System 10 may use third party payment gateway to receive the financial data, process the donation, and so on. System 10 is operable to securely receive and store the financial data so that the financial data is not accessible to other potential donors, the administrator, and the recipient.

At step 114, for each of the one or more received donations, system 10 stores data identifying the received donation in association with the corresponding potential donor (or actual payor at this step) that the payment was received from. System 10 is further operable to store data about the received payment in relation to the donation record for the specific donation collection. System 10 is further operable to store the received donation in association with the administrator record, the recipient record, or both. System 10 can provide data to administrator device 16 regarding the one or more received donations so that administrator can monitor donation collection. System 10 is operable to provide a notification to the administrator device 16 each time donations have been received for donation programs associated with the administrator.

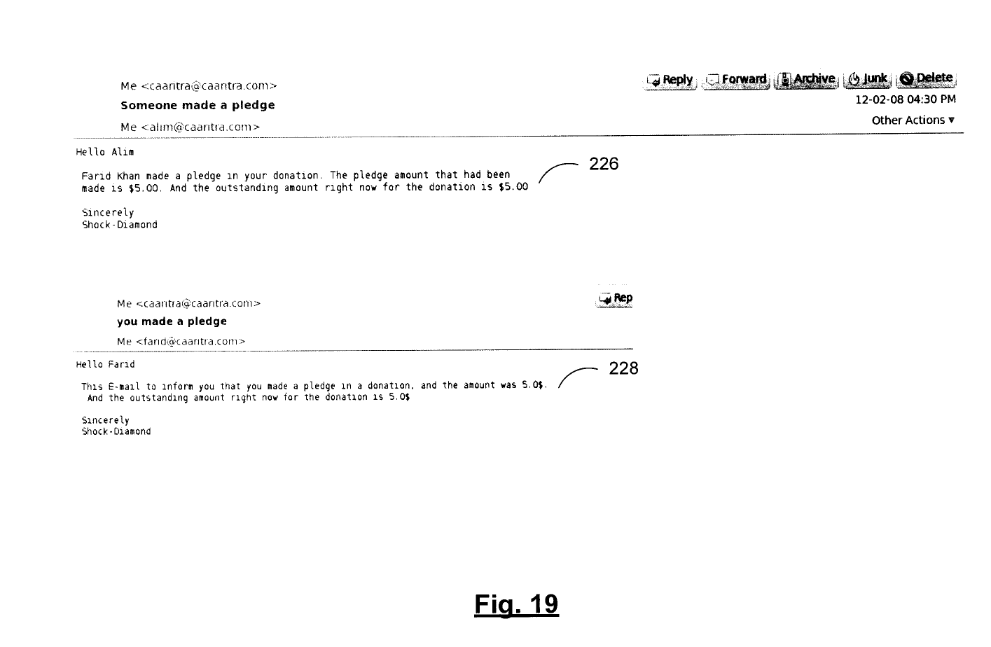

Referring now to FIG. 19 there is shown a notification 226 for provision to administrator device 16 indicating that a donor has made a donation for a donation program associated with the administrator. The notification 226 may identify the donor, the donation program, the donation amount, the amount outstanding for the donation program, and so on. FIG. 19 further shows a notification 228 for provision to a donor device 18 confirming receipt of the donation and the amount outstanding for the donation program.

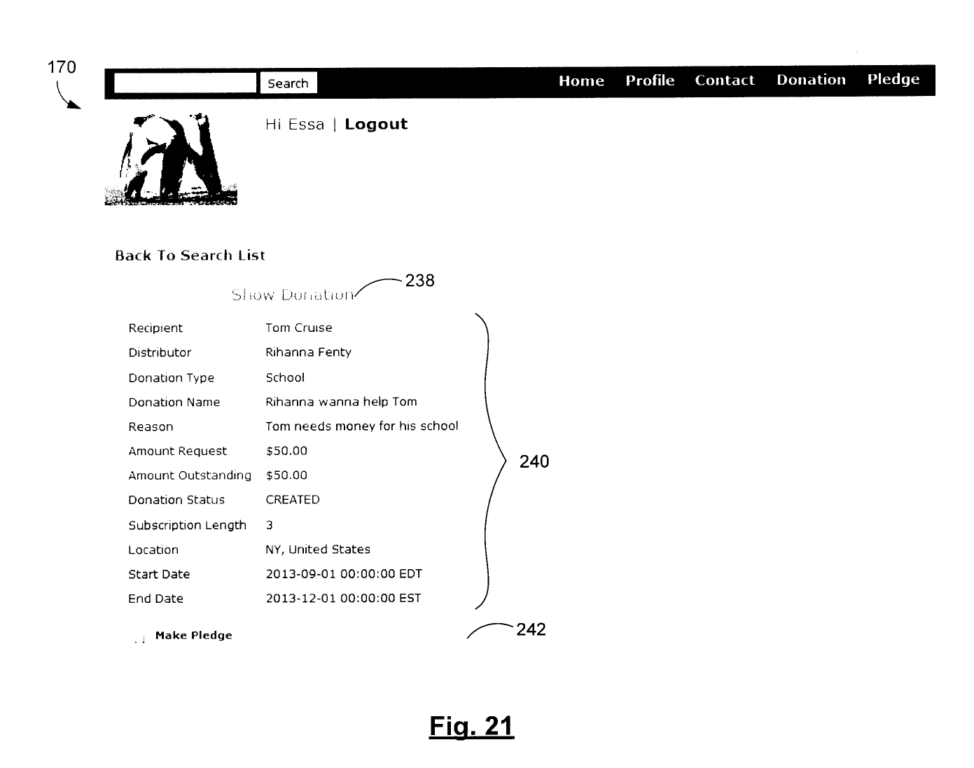

Referring now to FIG. 21 there is shown an interface 170 providing a donation request for a donation collection managed by system 10. A potential donor may not have received a donation request at an electronic address but may want to make a donation. A potential donor can access system 10 via interface 170 and request a list of all active donation collections (not shown) currently managed by the system 10 that are publically accessible (a donation may be private or public, as determined by a configurable permissions attribute). The potential donor can then activate a donation collection of the list of active donation collections by clicking on the title of the donation collection in interface 170, for example. In response, system 10 is operable to provide the example interface 170 illustrated in FIG. 21 which displays a donation page 238 with data fields 240 describing details of a specific donation collection. The potential donor can then review the donation page 238 to decide whether or not to contribute a donation. Accordingly, the donation page 238 may be another format of a donation request. Interface 170 may provide a ‘make donation’ button 242 for activation if the potential donor decides to make a donation for that specific donation collection. The potential donor may review donation pages 238 for multiple active donation collections before deciding which to donate to. Accordingly, system 10 may receive a donation at 112 in response to activation of the ‘make donation’ button 242.

Once system 10 has processed the received donations, then system 10 sums and reserves the received donations for the administrator. System 10 is operable to calculate and provide an outstanding amount for a donation program after receiving a donation. System 10 may place the received donations into an account associated with the administrator and the recipient. System 10 is operable to deduct an administrative fee from the received donations prior to placing the received payments in the account, or prior to disbursing the collected donations. System 10 is also operable to top up the payment with an administrative fee at the time of receiving donations from the donors such that system 10 directly receives both the donation for the recipient and the administrative fee from the donor.

System 10 is operable to combine all received donations associated with a donation program, the administrator, recipient, and so on. System 10 is operable to distribute the received donations to the administrator via electronic funds transfer, physical funds transfer and the like. System 10 may store financial data associated with the administrator and automatically distribute the received donations using the stored financial data. System 10 may distribute received donations periodically, such as weekly, monthly, each time a donation is received, when a threshold amount of donations are received, and so on. The administrator can then distribute the received donations to the recipient. For systems where funds are distributed to a charity organization prior to distribution to the recipient, often the costs of running the charity organization require a margin to be taken from the received donations, thus reducing the amount of donation provided to a person in need. System 10 may enable a larger percentage of the collected donations, such as all or substantially all, to go to the recipient. For example, system 10 may charge an administrative fee from each donor at the time of receiving donations so that the donation amount received for the recipient is not reduced. In accordance with some embodiments, system 10 is operable to distribute the received donations to the recipient via electronic funds transfer, physical funds transfer and the like. The disbursement may occur once a donation program is complete, which may be as a result of an end time, duration, total amount reached, and so on. Notification of the disbursement may be provided to all donors that donations were received from for a specific donation program. If a donation program collects a surplus (i.e. more than the total amount requested) then the surplus may be disbursed to the recipient, another program, and so on.

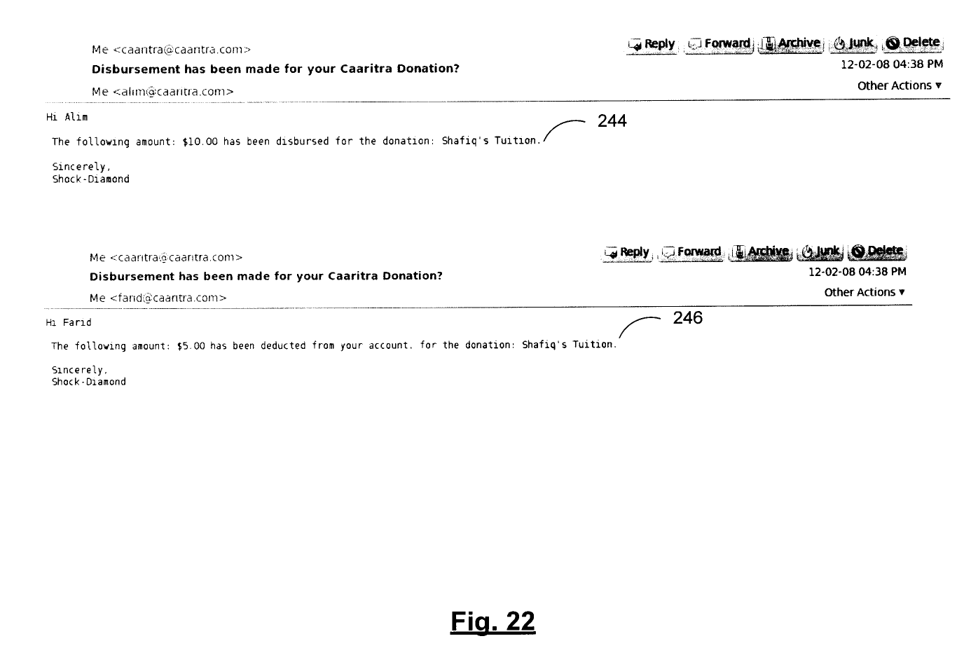

Referring now to FIG. 22 there is shown a notification 244 composed and provided by system 10 to an administrator indicating that a portion of the collected donations has been disbursed to the recipient. The notification may identify the donation program, the amount disbursed, the recipient, the amount remaining, and so on. There is also shown a notification 246 composed and provided by system 10 to a donor a donation was received from for the donation program indicating that a portion of the collected donations has been disbursed to the recipient. System 10 tracks data in order to automatically generate and provide notifications to all donors donations were received from in relation to a donation program.

In accordance with some embodiments, system 10 is operable to compute data relating to received payments and donations. For example, system 10 is operable to determine and store a number of times a payment for a donation was received from each donor, the total amount of donations collected by an administrator, the total amount of donations received for a specific recipient, and so on. System 10 is further operable to send to administrator device 16 a recommendation of one or more potential donors to send a donation request to, where the recommendation is based on the number of times a donation was received from the one or more donors.

System 10 is operable to implement steps 112 and 114 every time one or more payments for donations are received. System 10 is operable to return to steps 108 and 110 if a donation request is sent after a payment for a donation is received, or before a payment for a payment is received, at step 112.

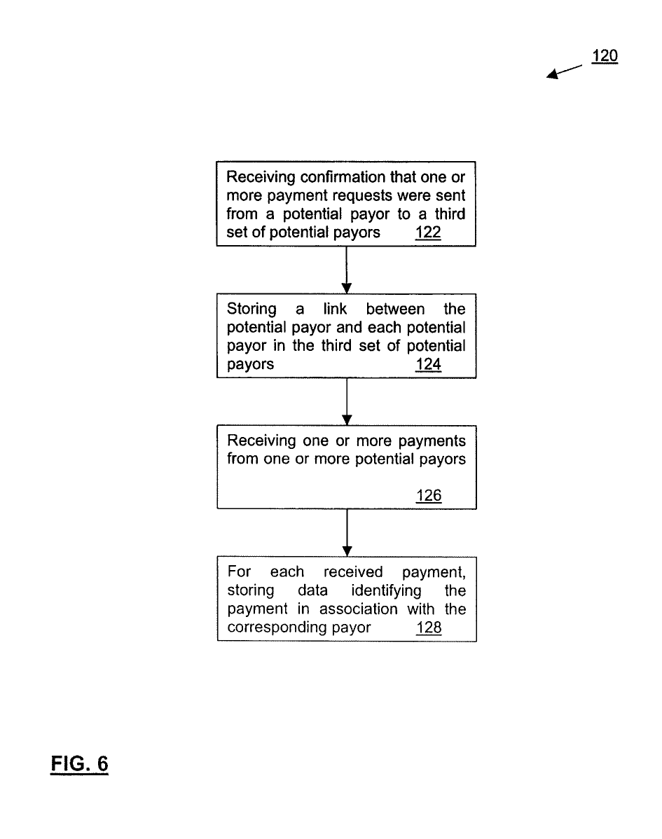

Referring now to FIG. 6, there is shown a flowchart diagram of a method 120 for managing payments in accordance with at least one other embodiment.

System 10 is operable to enable potential donors that have received a donation request to forward the donation request to other potential donors. An example interface 170 relating forwarding donation requests is shown in FIG. 20. An example method 120 is described in FIG. 6. At step 122, system 10 is operable to receive a confirmation that one or more donation requests were sent from a potential donor of the first or second set to a third set of potential donors over one or more networks, where the donation request is associated with the recipient, and administrator, and a donation collection. The third set of potential donors may include potential donors from the first set or second set of potential donors, new potential donors, or a combination thereof.

If system 10 receives a confirmation that one or more donation requests were sent from a potential donor of the second set of potential donors to a third set of potential donors over one or more networks, then at step 124, system 10 is operable to store a link between the potential donor record of the second set of potential donors and each potential donor record of the third set of potential donors in the database of memory store 44. System 10 stores a link to track all potential donors that received a donation request and how the potential donor received the donation request. For example, if a potential donor A sent a request to potential donor B, who in turn sent a request to potential donor C, then system 10 is operable to track that potential donor received a payment request via potential donor A and potential donor B. System 10 tracks this data to send status updates and notifications, compute data regarding payment behavior, compute recommendations for potential donors, compute ratings, and so on. System 10 is operable to receive confirmations that one or more donation requests were sent from a potential donor of the third set of potential donors to a fourth set of potential donors over one or more networks, and so on. In response, system 10 is operable to store links between a potential donor of the third set and the fourth set of potential donors, and so on

At step 126, system 10 is operable to receive one or more payments for donations from one or more of the potential donors in the third set, substantially as described in relation to step 112 (FIG. 4).

At step 128, for each received payment, system 10 is operable to store data identifying the payment in association with the corresponding donor record, substantially as described in relation to step 114 (FIG. 4). System 10 is further operable to generate and store a donation record including payment details. The method described in relation to FIGS. 4 and 6 may apply to a fourth set of potential donors, fifth set of potential donors, sixth set of potential donors, and so on.

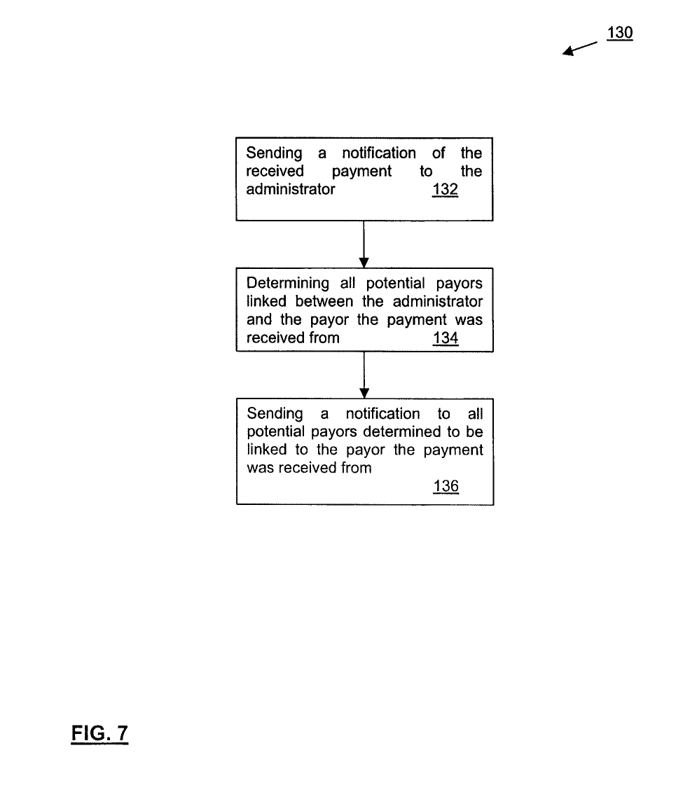

Referring now to FIG. 7, there is shown a flowchart diagram of a method 130 for sending notifications of payments for donations in accordance with at least one embodiment. System 10 is operable to configure when notifications are sent. For example, system 10 may implement method 120 for each received donation, specific received payments, over a threshold amount of received payments and so on.

At step 132, system 10 sends a notification of the received donation to the administrator collecting payments on behalf of the recipient. An example notification is shown in FIG. 19. System 10 is configurable to send notifications upon then occurrence of different events. For example, system 10 is operable to send a notification each time a donation is received. System 10 is further operable to send a notification periodically, such as weekly, and compute a summary of all received donation, or all received payments since the last notification was sent, for provision in the notification. As another example, system 10 is further operable to send a notification when a threshold amount of donations have been received.

At step 134, system 10 determines the potential donors linked between the administrator record and the potential donor the payment was received from. System 10 determines these potential donors using the stored links, donor records, donation records, and administrative records, in a recursive manner for example. Referring to FIG. 5 as an example, if a donation is received from potential donor 70e then system 10 uses the stored links to determine that potential donor 70d record is linked between the administrator 66 record and potential donor 70e record. As another simplified example, a donation request may be sent by the administrator to potential donor A, and then by potential donor A to potential donor B, and then by potential donor B to potential donor C, and finally by potential donor C to potential donor D. If system 10 receives a payment for a donation from potential donor D then system 10 is operable to determine that potential donor A, potential donor B, and potential donor C are linked between the administrator and potential donor D. System 10 is operable to store links between potential donors from all sets potential donors.

At step 136, system 10 is operable to send a notification to one or more potential donors determined to be linked between the administrator and the potential donor the donation was received from. Referring back to the simplified example, system 10 is operable to send a notification that a payment was received from potential donor D to one or more of potential donor A, potential donor B, and potential donor C. The notification may indicate the link between the administrator record and potential donor D record, and may list the one or more potential donors in the link. For example, the notification to potential donor B may indicate that a donation was received as a result of sending a payment request to potential donor C, even though system 10 did not receive payment directly from potential donor C. In accordance with some embodiments, the next time system 10 receives confirmation that potential donor B received a donation request, system 10 is operable to send a recommendation to potential donor B to send a donation request to potential donor C, as it may result in another donation.

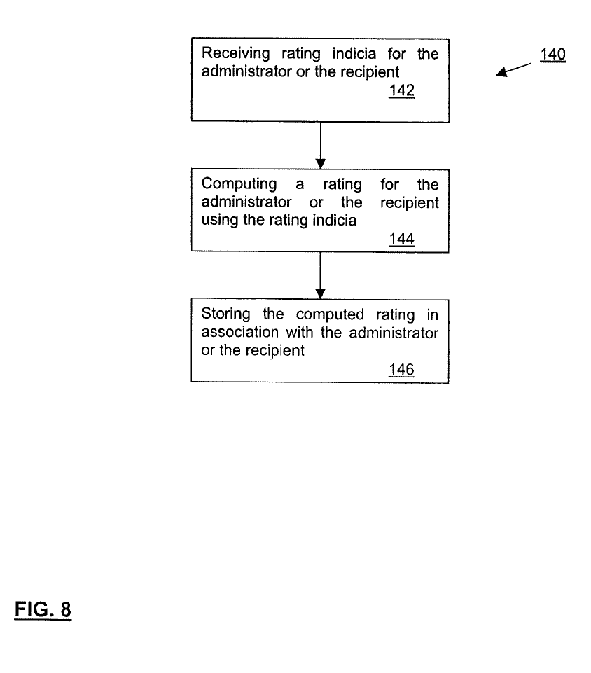

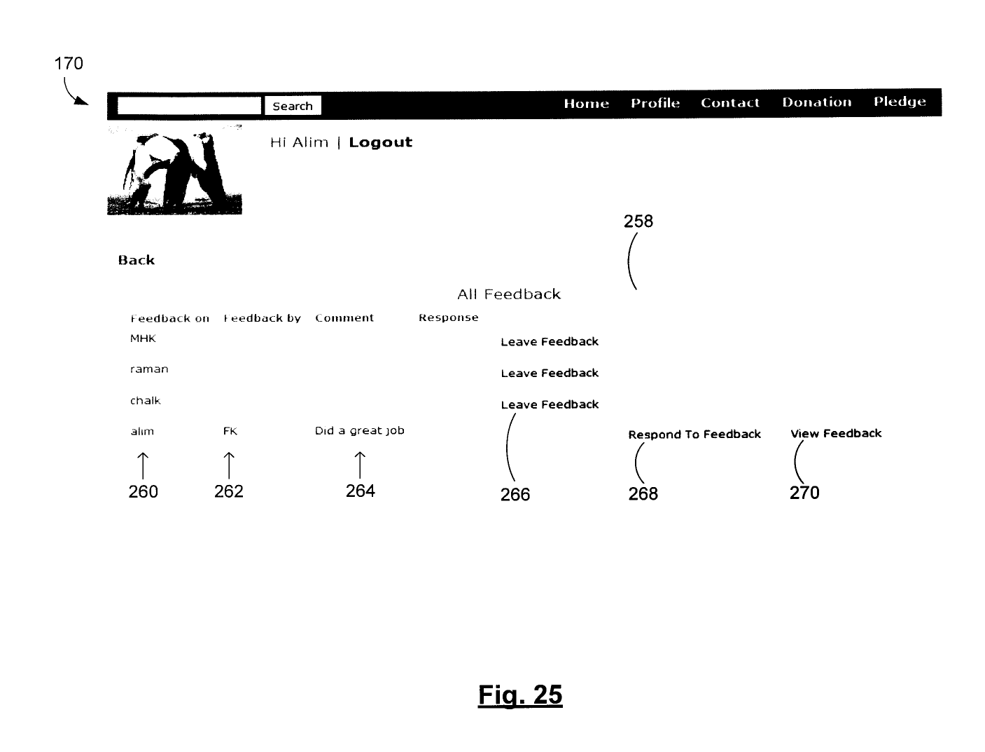

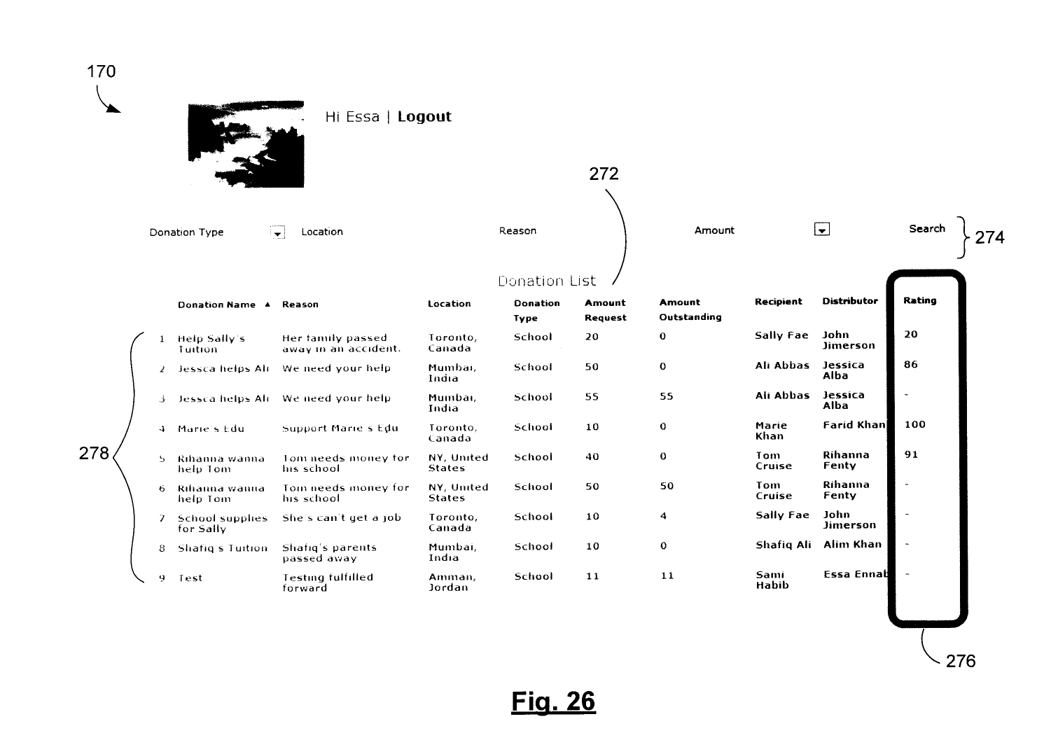

Referring now to FIG. 8, there is shown a flowchart diagram of a method 140 for managing ratings in accordance with at least one embodiment. Example interfaces 170 relating to ratings will be described in relation to FIGS. 25 and 26.

As shown in FIG. 8, at step 142, system 10 receives rating indicia for the administrator or the recipient from one or more potential donors. The rating indicia may be based on various factors. For example, rating indicia for the recipient may relate to the quality of feedback and status updates, amount of donations collected for the recipient, number of donation programs relating to the recipient, time frame for feedback and status updates, comments left by recipient, flags regarding fraud, and so on. As another example, rating indicia for the administrator may relate to the total amount of donation collected by the administrator, the number of donation programs associated with the administrator, quality of the recipients associated with the administrator, the number of donation requests initiated by the administrator and so on. The rating indicia may be based on one or more received ratings for the status update message of the recipient. System 10 is operable to receive feedback indicia from one or more potential donors, where the feedback indicia may be in relation feedback and status update associated with the administrator or the recipient. The rating indicia may be based on the one or more received feedback indicia.

At step 144, system 10 computes a rating for the administrator or the recipient using the rating indicia and feedback indicia. System 10 is configured to compute a rating according to a rating algorithm using the received rating indicia and feedback indicia along with other computed ratings. For example, system 10 is operable to compute a rating for an administrator based on the computed rating for the associated recipient. As another example, system 10 is operable to compute a rating for an administrator based on the received rating indicia in relation to feedback messages, status updates, and comments. In accordance with some embodiments, system 10 is operable to compute a rating based on the amount of donations collected by an administrator or recipient. As an example, if an administrator collects a large amount of payments for a particular recipient and the administrator receives negative rating indicia for status updates from that recipient, then system 10 may compute a lower rating for the administrator, then if the administrator collected a smaller amount of donations for a particular recipient. In accordance with some embodiments, system 10 is operable to weight each rating indicia to determine the amount of influence the rating indicia will have on the overall computed rating. For example, rating indicia in relation to status updates may have a larger weight than rating indicia in relation to the number of recipients a particular administrator has collected payments for. As another example, rating indicia received from a particular donor may have a larger weight that rating indicia received from another donor.

At step 146, system 10 stores the computed rating in association with the administrator record or the recipient record. System 10 stores the computed rating for subsequent re-computation, display or provision to potential donors. For example, a computed rating for an administrator or recipient may be included in the donation request as an indication of how reliable, accountable, trustworthy, dependable, and the like, the administrator or recipient is.

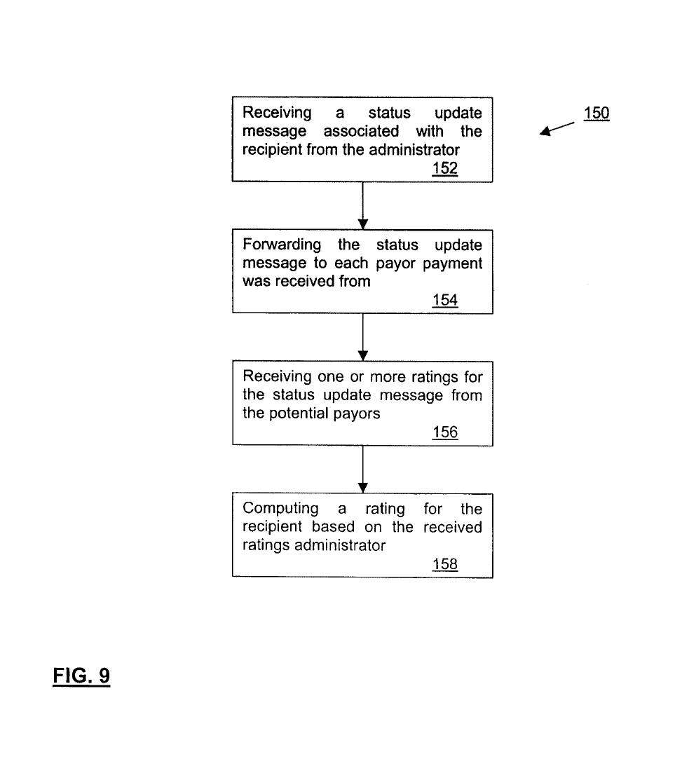

Referring now to FIG. 9, there is shown a flowchart diagram of a method 150 for providing feedback and status updates received by system 10 in relation to a recipient in accordance with at least one embodiment.

At step 152, system 10 receives feedback or a status update message associated with the recipient. The status update message may be received from administrator device 16 or another device. The status update may include text, video, audio, image, or a combination thereof. System 10 may receive a status update message after distributing some or all of the received donations to the recipient or administrator. The status update may indicate how the donations are being used by the recipient. For example, the recipient may use the donation to build a house and the status update may indicate house building progress and the stage the house is at. The status update may include images of the house and recipient, or videos of the house building progress. The status update message may indicate the current status of the recipient. For example, the recipient may be sick with the donations used for treatment, and the status update message may indicate the treatment progress and how the recipient is doing. Status updates may be sent on a periodic basis, such as monthly, or after the occurrence of a specific event. The recipient or administrator may be required and obligated to provide a specific number of status updates and specified due dates and times. As another example, the recipient may be using the donations for school and the status update messages may be electronic copies of report cards and school pictures.

System 10 is operable to log the administrator in using a user name or password, and select the recipient the status update relates to. System 10 receives the status update and stores the status update in association with the administrator record and the recipient record.

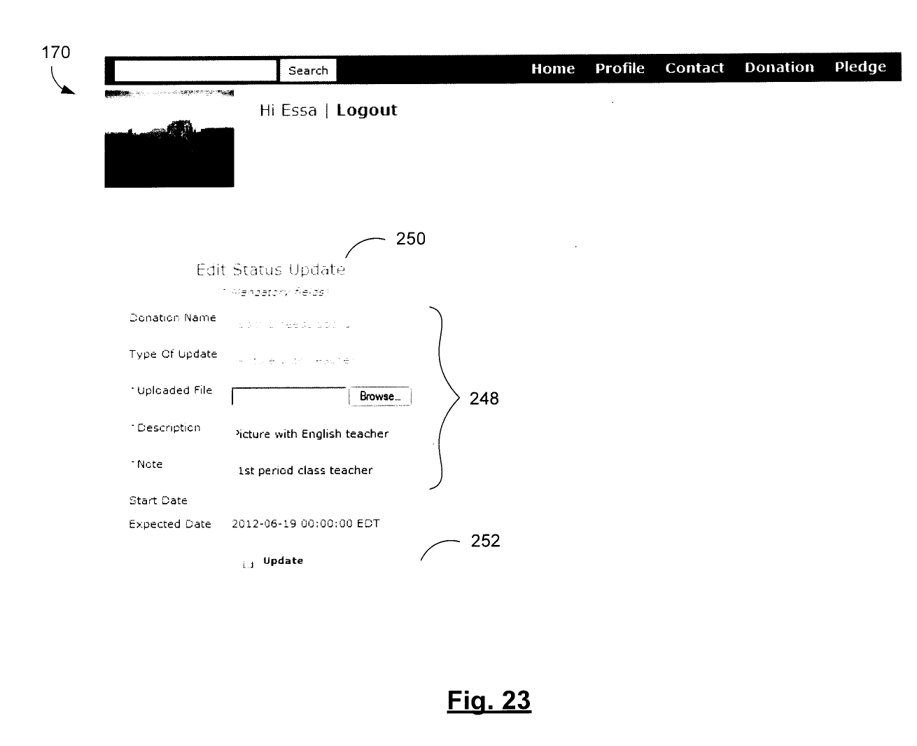

Referring now to FIG. 23 there is shown an interface 170 displaying a status update page 250 for receiving status updates. The edit/create status update page 250 includes various fields 248 for receiving and editing data relating to the status update. For example, the fields 248 may include donation program name, type of status update (picture, video, text, report card), file upload, description, note, date, start date, end date, due date, and so on. If the status update is being edited then the fields 248 may display the previously received data. System 10 is operable to provide an update button that may be activated once the data for the status update message is provided in the fields 248 so that the data may be transmitted from the interface 170 to system 10 and stored in memory store 44 in a status update record or the like.

At step 154, system 10 forwards the status update message over one or more networks to each of the potential payors that payments were received from. System 10 is operable to forward the status update message over social network 20 using API of the social network 20, for example. System 10 is operable to store an electronic address in association with each of the potential payors that payments were received from in order to send the status update messages. System 10 is further operable to display a representation of the status update message.

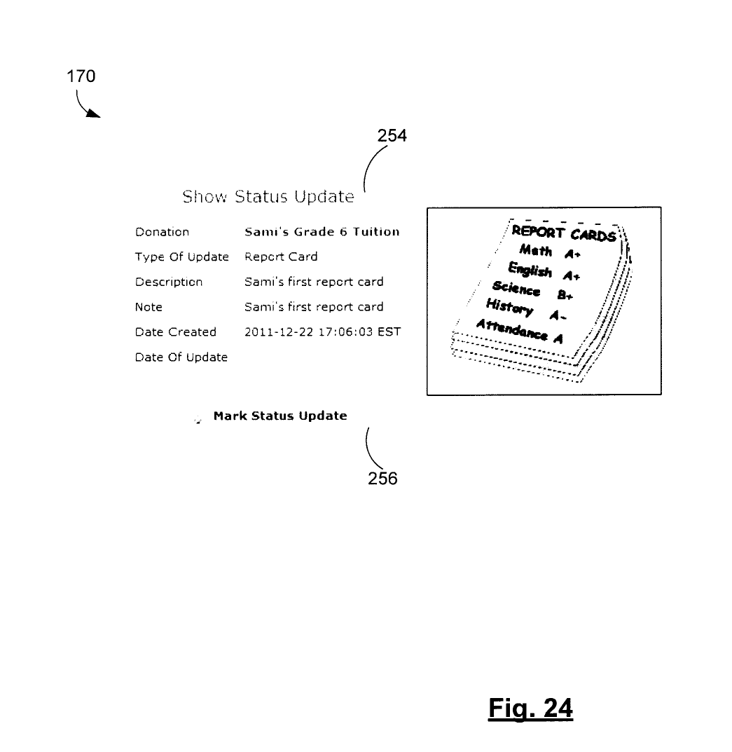

Referring now to FIG. 24 there is shown an interface 170 displaying a show status update page 254 with details regarding the status update. For an example relating to tuition, the status update page 254 may include the name of the donation program, the type of update, the description, a note, creation date and picture of a report card. This is an example only and the status update page 254 may display additional data such as movies, pictures, slideshows and so on. System 10 is operable to provide a ‘mark status update’ button 256 to receive feedback and rating indicia relating the to the status update.

In accordance with some embodiments, system 10 maintains a rating system for administrators, recipients, potential donors, or a combination thereof, as explained in relation to FIG. 8.

At step 156, system 10 receives feedback rating indicia in relation to the one or more status update messages from potential donors that received or viewed the status update messages. For example, the donation request may indicate that a status update message will be sent every 6 months with details on how the received donations are being used. If the status message is not sent every 6 months then the administrator, the recipient, or both may receive a negative rating in relation to status update messages. As another example, the status update message may include a detailed video on how the received payments were used or disbursed, and a detailed video may receive a positive rating. As a further example, the status update message may include little to no detail about the progress of the recipient and the recipient may receive a negative rating or a request for further information.

Referring now to FIG. 25 there is shown an interface 170 for collecting feedback indicia regarding recipients, status update messages, and so on. The interface 170 may provide a feedback page 258 showing listing of recipients, administrators, and associated feedback or mechanisms to provide feedback. For example, the feedback page 258 may be a table with a ‘feedback on’ list 260 listing recipients or administrators the feedback relates to, a ‘feedback by’ list 262 listing the donors that provided the feedback, a comment list 264 listing any received feedback, a ‘leave feedback’ button 266 for receiving feedback indicia, a ‘respond to feedback’ button 268 for responding to feedback indicia (a recipient, administrator, or donor can respond to feedback), a ‘view feedback’ button 270 for viewing feedback. System 10 is operable to screen feedback prior to display for review and approval by a customer service representative for example.

In accordance with some embodiments, system 10 is operable to associate each type of donation program with a standard set of required status updates. For example, if the type is for school then monthly status updates may be required, along with a photo and 2 report cards, for example. The standard set of status updates may be configured and customized.

At step 158, system 10 computes or updates a rating for the recipient or the administrator based on the received rating indicia in relation to the one or more status update messages. System 10 is operable to compute the rating using a rating algorithm that aggregates all received rating indicia for the administrator, recipient, or payor. As described herein, system 10 may attach a weight to the received the rating indicia in order to compute the rating.

Referring now to FIG. 26 there is shown an interface 170 displaying a donation listing page 272 providing details regarding donation programs. For example, the donation listing page 272 may show the name of the donation program, the reason for the donation program, the location of the donation program, the type of the donation program, the donation amount requested, the donation amount outstanding, the recipient, the administrator (or distributor), and the rating 276 for the donation program. The rating 276 of the donation program may be computed based on ratings associated with the recipient and the administrator. Each donation program in the donation listing page 272 is selectable and system 10 is operable to display a donation page for the selected donation along with details about the donation program and a ‘donate’ button for receiving payment for a donation for the donation program. The donation listing page 272 may also provide a search interface 274 for receiving search criteria about donation programs and in response may provide search results listing donation programs matching the received search criteria. For example, the search criteria may include donation type, location, reason, amount requested, amount outstanding, and so on. Potential donors may use the search interface 274 and donation listing page 272 to review donation programs and decide whether to donate.

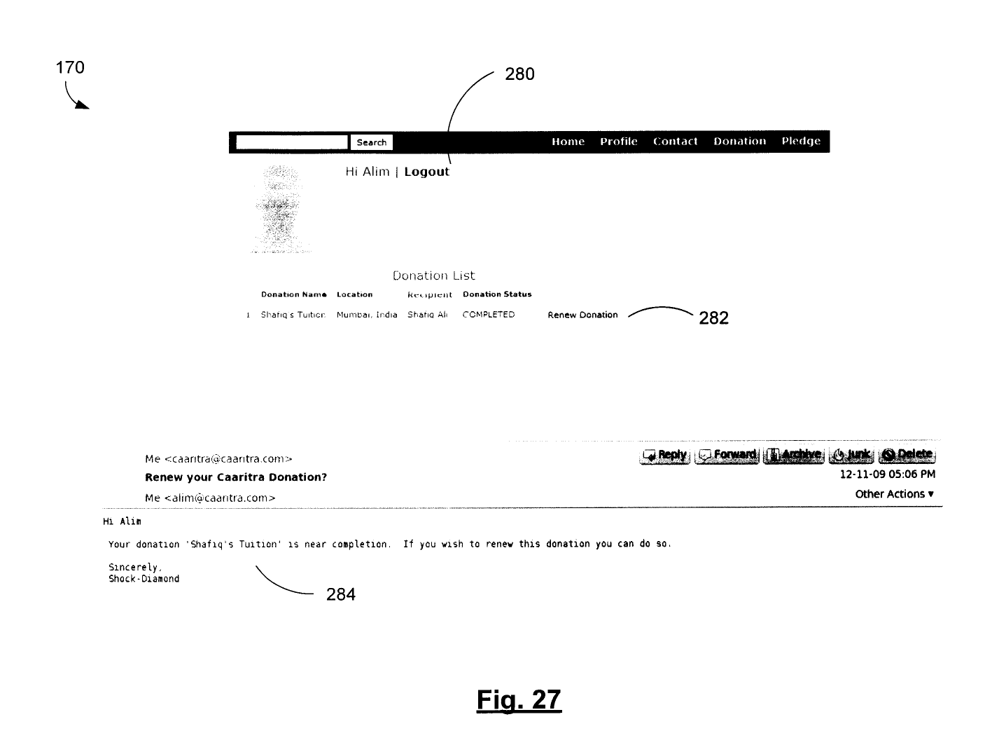

Referring now to FIG. 27 there is shown an interface 170 providing a renewal page 280 for renewing a donation. The renewal page 280 may provide a donation list of donation programs associated with the administrator. The renewal page 280 may provide a ‘renew donation’ button 282 in association with a donation program so that when a donation program is completed then an administrator may renew the donation program and continue to collect donations on behalf of the recipient. For example, the donation program may be to raise money for school for a recipient and each year the donation program may be renewed to continue to collect donations for the recipient. System 10 is operable to provide a notification 284 to an administrator indicating that a donation program is complete or near completion and may be renewed. The notification 284 may include a link to the renewal page 280. System 10 is operable to enable updates and edits to the donation program on renewal. For example, the amount of donation requested may change.

The present invention has been described here by way of example only. Various modification and variations may be made to these exemplary embodiments without departing from the spirit and scope of the invention, which is limited only by the appended claims.

1. A method for managing payments wherein the method is implemented by a computer comprising a processor and a memory storing computing instructions to configure the processor to implement the method comprising:
registering an administrator by storing an administrator record in the memory, wherein the administrator collects payments on behalf of a recipient;
registering the recipient by storing a recipient record in the memory;
receiving a confirmation that one or more payment requests were sent to a first set of one or more potential payors over one or more networks, wherein the one or more payment requests are associated with the recipient and the administrator;
storing a payor record in memory for each potential payor of he first set of one or more potential payors;
storing a link between the administrator record and each payor record for the first set of one or more first potential payors in the memory;
receiving a confirmation that one or more payment requests were sent from a potential payor of the first set of one or more potential payors to a second set of one or more potential payors over a network, wherein the one or more payment requests are associated with the recipient;
storing a payor record in memory for each potential payor of the second set of one or more potential payors;
storing a link between payer record for the payor of the first set of one or more potential payors and each payor record for the second set of one or more potential payors in the database;
receiving one or more payments for the recipient from a corresponding one or more payors of the second set of one or more potential payors; and
for each of the one or more received payments, storing data identifying the received payment in association with the corresponding payor record.

2. The method of claim 1 further comprising:
for each of the one or more received payments, sending a notification of the received payment to the administrator.

3. The method of claim 1 further comprising:
for each of the one or more received payments, sending a notification of the received payment to the potential payor of the first set of one or more potential payors.

4. The method of claim 1 further comprising;
receiving a confirmation that one or more payment requests were sent from, a potential payor of the second set of one or more potential payors to a third set of one or more potential payors over a network, wherein the one or more payment request is associated with the recipient;
storing a payor record in memory for each potential payer of the third set of one or more potential payors;
storing a link between payor record of the potential payer of the second set of one or more potential payors and each payer record for the third set of one or more potential payors in the memory;
receiving one or more payments for the recipient from a corresponding one or more payors of the third set of one or more potential payers; and
for each of the one or more received payments, storing data identifying the received payment in association with the corresponding payer record.

5. The method of claim 1 further comprising:
receiving a status update message associated with the recipient; and
forwarding the status update message to each of the one or more payers payments were received from.

6. The method of claim 1 further comprising:
sending a payment subscription request to the each potential payor of the first set of potential payors and the second of potential payors, wherein the payment subscription request defines a periodic time for payment;
receiving payment subscription authorizations from one or more potential payors of the first set of potential payers and the second of potential payors;
recording data identifying the payment subscription authorization in association with the each of the one or more payer records payment subscription authorizations were received from; and
at each occurrence of the periodic time for donating, receiving a payment for the recipient from each of the one or more potential payors payment subscription authorizations were received from.

7. The method of claim 6 further comprising:
at each occurrence of the periodic time for donating, sending a payment reminder to each of the one or more potential payors payment subscription authorizations were received from.

8. The method of claim 1 further comprising:
receiving rating indicia for the administrator from one or more potential payors of the first set of potential payors and the second of potential payors;
computing a rating for the administrator using the rating indicia; and
storing the computed rating in association with the administrator record.

9. The method of claim 8 wherein the rating indicia is based on the total amount of payments received from the first set of potential payors and the second of potential payors.

10. The method of managing payments of claim 9 further comprising:
receiving a status update message associated with the recipient from the administrator;
forwarding the status update message to each payor payment for the recipient was received from; and
receiving one or more ratings for the status update message from one or more potential payors that the status update message was forwarded to; and
wherein the rating indicia is based on one or more received ratings for the status update message.

11. The method of claim 1 further comprising receiving one or more feedback indicia in relation to the administrator from one or more potential payors of the first set of potential payors and the second of potential payors; and wherein the rating indicia is based on the one or more received feedback indicia.

12. The method of claim 1 further comprising:
receiving rating indicia for the recipient from one or more potential payors of the first set of potential payors and the second of potential payors, computing, a rating for the recipient using the rating indicia; and
storing the computed rating in association with the recipient record.

13. The method of claim 1 further comprising:
for each received confirmations that one or more payment requests were sent:
receiving a date and time of the payment request; and
storing the received date and time.

14. The method of claim 1 further comprising:
for each potential payor:
determining a number of times a payment request was sent to the potential payor; and
storing the number of times in association with the payor record.

15. The method of claim 1 further comprising:
for each payor;
determining a number of times a payment was received from the payor; and
storing the number of times in association with the payor record.

16. The method of claim 15 further comprising:
sending a recommendation of one or more potential payors to send a payment request to, wherein the recommendation is based on the number of times payment was received from the one or more potential payors.

17. The method of claim 1 wherein the method relates to managing donations, wherein the payments are donations received for the recipient, wherein the potential payors are potential donors.

18. The method of claim 1 further comprising:
receiving government identification for the recipient; and
verifying the recipient by verifying the government identification.

19. A computer-readable storage device comprising a plurality of instructions for an application, the application for execution on a computing device, the instructions for performing a method of managing payments comprising:
registering an administrator by storing an administrator record in the memory, wherein the administrator collects payments on behalf of a recipient;
registering the recipient by storing a recipient record in the memory;
receiving a confirmation that one or more payment requests were sent to a first set of one or more potential payors over one or more networks, wherein the one or more payment requests are associated with the recipient and the administrator;
storing a payor record in memory for each potential payor of the first set of one or more potential payors;
storing a link between the administrator record and each payor record for the first set of one or more first potential payors in the memory;
receiving a confirmation that one or more payment requests were sent from a potential payor of the first set of one or more potential payors to a second set of one or more potential payors over a network, wherein the one or more payment requests are associated with the recipient;
storing a payor record in memory for each potential payor of the second set of one or more potential payors;
storing a link between payor record for the payor of the first set of one or more potential payors and each payor record for the second set of one or more potential payors in the database;
receiving one or more payments for the recipient from a corresponding one or more payors of the second set of one or more potential payors; and
for each of the one or more received payments, storing data identifying the received payment in association with the corresponding payor record.

20. A system for managing payments, the system comprising a processor and a memory on which an application is installed; wherein execution of the application causes the processor to:
register an administrator by storing an administrator record in the memory, wherein the administrator collects payments on behalf of a recipient;
register the recipient by storing a recipient record in the memory;
receive a confirmation that one or more payment requests were sent to a first set of one or more potential payors over one or more networks, wherein the one or more payment requests are associated with the recipient and the administrator;
store a payor record in memory for each potential payor of the first set of one or more potential payors;
store a link between the administrator record and each payor record for the first set of one or more first potential payors in the memory;
receive a confirmation that one or more payment requests were sent from a potential payor of the first set of one or more potential payors to a second set of one or more potential payors over a network, wherein the one or more payment requests are associated with the recipient;
store a payor record in memory for each potential payor of the second set of one or more potential payors;
store a link between payor record for the payor of the first set of one or more potential payers and each payor record for the second set of one or more potential payors in the database;
receive one or more payments for the recipient from a corresponding one or more payors of the second set of one or more potential payors; and
for each of the one or more received payments, store data identifying the received payment in association with the corresponding payor record.
